(19) United States
(12) Patent Application Publication
(10) Pub. No.: US 2026/0182761 A1
(43) Pub. Date: Jul. 2, 2026

(54) FOOD SERVING SYSTEM

(71) Applicant: Lifetime Brands, Inc., Garden City, NY (US)

(72) Inventors: YoungJin Seo, Fresh Meadows, NY (US); Adam Krent, Brooklyn, NY (US)

(21) Appl. No.: 19/544,377

(22) Filed: Feb. 19, 2026

Related U.S. Application Data
(63) Continuation-in-part of application No. 19/001,805, filed on Dec. 26, 2024.

(51) Int. Cl. A47G 23/06; A47J 47/00; A47J 47/14

(52) U.S. Cl. CPC A47G 23/0683; A47J 47/005; A47J 47/14; A47G 2023/0691

(57) ABSTRACT

A food serving system includes a board having a geometric shape with an edge around the same. A cover has the same geometric shape as the board, and a dual stage locking handle is configured to lock the board in both a first serving position and a second storage position, when the board is reversed from the first position. The dual stage locking handle includes a transverse extension to guide the dual stage locking handle to be translated away from the board and pivot away to permit removal of the board from the cover.

### CROSS REFERENCE TO RELATED APPLICATIONS

This application is a Continuation-in-Part of co-pending U.S. patent application Ser. No. 19/001,805 filed on Dec. 26, 2024, the entire contents of which are incorporated herein by reference.

### BACKGROUND

### Technical Field

The present invention relates to food preparation and serving. More particularly, it relates to a food serving system including a cover having multiple functions.

### Description of the Prior Art

When it comes to the preparation and serving of food, it will be appreciated that the tools used for each are mutually exclusive of each other. Very often the food is prepared using cookware, and other food preparation utensils, and once food prep is completed, the prepared food is moved to some separate form of serverware.

### SUMMARY OF THE INVENTION

The present invention provides a food serving system having a base board of a predetermined geometric shape having an edge around the same, the edge having at least one indentation. A cover having the same geometric shape as the based includes at least one dual stage locking handle configured to lock the board in both a first covered position when covered by the cover, and a second nested position when the base board is nested within the cover turned upside down.

In one implementation, the board includes two indentations positioned opposite each other, and the cover includes at least two dual stage locking handles, each configured to engage one of the indentations.

In another implementation, the board further includes at least one indentation causing the board to have a thickness substantially equal to the space between the transverse extension (3022) and the snapping nub (3024) such that the when the cover is positioned over the board to cover the same in the first position, the at least one handle is pivoted downward such that transverse extension and snapping nub snap over the edge of the board and lock the cover to the board in the first position.

In accordance with one aspect, the dual stage locking handle is pivotally connected to the cover at pivot connection point having an inner surface. A transverse extension extends from the inner surface, and a snapping nub spaced from the transverse extension. When in the second nested position, the edge of the board in the area of the at least one indentation fits between the transverse extension and the snapping nub thereby securing the board in the second nested position.

According to another implementation, the food serving system includes a board having a predetermined geometric shape with an edge of a predetermined thickness around the same. A cover has the same predetermined geometric shape as the board, and at least one dual stage locking handle configured to engage the edge and lock the board in both a first position when covered by the cover, and a second position when the board is nested within the cover turned upside down.

Other aspects and features of the present principles will become apparent from the following detailed description considered in conjunction with the accompanying drawings. It is to be understood, however, that the drawings are designed solely for purposes of illustration and not as a definition of the limits of the present principles, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings wherein like reference numerals denote similar components throughout the views:

FIG. 1 shows a perspective view of the food preparation and serving system according to an embodiment of the invention;

FIG. 2A shows an exploded perspective view of the embodiment shown in FIG. 1;

FIG. 2B shows an exploded perspective view of the food preparation and serving system according another embodiment of the invention;

FIG. 2C shows an exploded perspective view of the food preparation and serving system according a further embodiment of the invention;

FIG. 2D shows an exploded perspective view of the food preparation and serving system according yet another embodiment of the invention;

FIG. 2E shows an exploded perspective view of the food preparation and serving system according another embodiment of the invention;

FIG. 2F shows an exploded perspective view of the food preparation and serving system according another embodiment of the invention;

FIG. 2G shows an exploded perspective view of the food preparation and serving system according another embodiment of the invention;

FIG. 2H shows an exploded perspective view of the food preparation and serving system according another embodiment of the invention;

FIGS. 3A, 3B, 3C, 3D and 3E show plan views of alternative bowl shapes and configurations according to other embodiments of the invention;

FIGS. 4A-4G show top views of alternative cover shapes with their corresponding combined serving trays/cutting boards according to further embodiments of the invention;

FIGS. 5A, 5B and 5C show plan views of alternative cover designs for the food preparation and serving system, according to alternative embodiments of the invention;

FIGS. 6A, 6B, 6C, 6D, 6E and 6F show plan views of alternative combined serving trays/cutting boards according to yet further embodiments of the invention;

FIGS. 7A, 7B, 7C, 7D, and 7E show cross-sectional views of alternative profiles for seating the combined serving tray/cutting board into the bowl, according to alternative embodiments of the invention;

FIGS. 8A, 8B, 8C, 8D, 8E, 8F, 8G and 8H show different views of alternative cover handle implementations according to alternative embodiments of the invention;

FIGS. 9A, 9B, 9C, 9D, and 9E show an alternative locking mechanism for locking the cover to the bowl, according to other embodiments of the invention;

FIG. 10 shows a perspective view of a food serving system including a base board and a cover with dual stage locking handles, in accordance with an embodiment of the present invention;

FIG. 11A shows a side view of the food serving system in a storage or carrying configuration, in accordance with an embodiment of the present invention;

FIG. 11B shows a cross-sectional view of the food serving system in the storage or carrying configuration, in accordance with an embodiment of the present invention;

FIGS. 12A, 12B and 12C show cross-sectional views of various stages of the handle operation of the food serving system, in accordance with an embodiment of the present invention;

FIG. 13 shows a top perspective view of the food serving system with the cover inverted and the base board resting within the same, in accordance with an embodiment of the present invention;

FIG. 14A shows a side view of the food serving system in a serving configuration, in accordance with an embodiment of the present invention;

FIG. 14B shows a cross-sectional view of the food serving system in the serving configuration, in accordance with an embodiment of the present invention;

FIG. 14C shows a partially exploded view of the cover and the dual stage locking handles of the food serving system, in accordance with an embodiment of the present invention;

FIG. 14D shows an enlarged view of the dual stage locking handles, in accordance with an embodiment of the present invention;

FIGS. 15A, 15B and 15C show cross-sectional views of various stages of the handle operation of the food serving system when transitioning to or from the serving configuration, in accordance with an embodiment of the present invention;

FIGS. 16A and 16B show a top view and cross-sectional view, respectively, of the food serving system in the storage or carrying position, in accordance with an embodiment of the present invention;

FIGS. 17A and 17B show a top view and cross-sectional view, respectively, of the food serving system in the serving position, in accordance with an embodiment of the present invention;

FIG. 17C shows a magnified view of a gasket detail of the food serving system, in accordance with an embodiment of the present invention;

FIG. 18 shows the serving system having the cover attached to the base board by spring loaded locking handles in a storage configuration, in accordance with an embodiment of the present invention;

FIG. 19A shows a cross-sectional view of the serving system of FIG. 18, in accordance with an embodiment of the present invention;

FIG. 19B shows an enlarged view of a locking handle detail from FIG. 19A, in accordance with an embodiment of the present invention;

FIG. 20 shows the serving system having the cover attached to the base board by locking handles in a serving position, in accordance with an embodiment of the present invention;

FIG. 21A shows a cross-sectional view of the serving system of FIG. 20, in accordance with an embodiment of the present invention; and

FIG. 21B shows an enlarged view of a locking handle detail from FIG. 21A, in accordance with an embodiment of the present invention;

### DETAILED DESCRIPTION

The following detailed description presents various implementations of a food serving system that may be used for food preparation, storage, transport, and serving. The food serving system may include a base board (or board) and a cover that work together in multiple configurations to provide versatility in use. In some aspects, the base board may include compartments on one surface for receiving food items and a cutting board surface on an opposite surface. The cover may be configured to engage the base board in different orientations, allowing the system to transition between storage, transport, and serving modes.

In some implementations, the food serving system may include dual stage locking handles that secure the base board to the cover in multiple positions. The dual stage locking handles may be pivotally connected to the cover and may include features such as transverse extensions, hinge rods, and track members that facilitate engagement and disengagement of the base board. In some cases, the locking handles may include a lower portion configured to capture an undercut or surface on the base board to secure the components together.

The food serving system may also include gaskets or sealing elements positioned between the cover and the base board. In some aspects, the gaskets may provide a seal to protect food items during storage or transport. The gaskets may also provide an interference fit between the cover and the base board in some implementations.

In some embodiments, the cover may be invertible such that it serves as a base or tray in a serving configuration. When inverted, the cover may receive the base board in a nested position with the compartments exposed for serving food items. Support feet may be provided on the cover to provide stability when the cover is used in the inverted serving configuration.

Various locking mechanisms are contemplated for securing the base board to the cover. In some implementations, spring loaded locking handles may be employed that bias toward a closed position. The locking handles may include an anchor portion secured to the cover and a handle portion coupled via a hinged connection. The handle portion may include a lock portion configured to engage a recess in the base board to secure the components together.

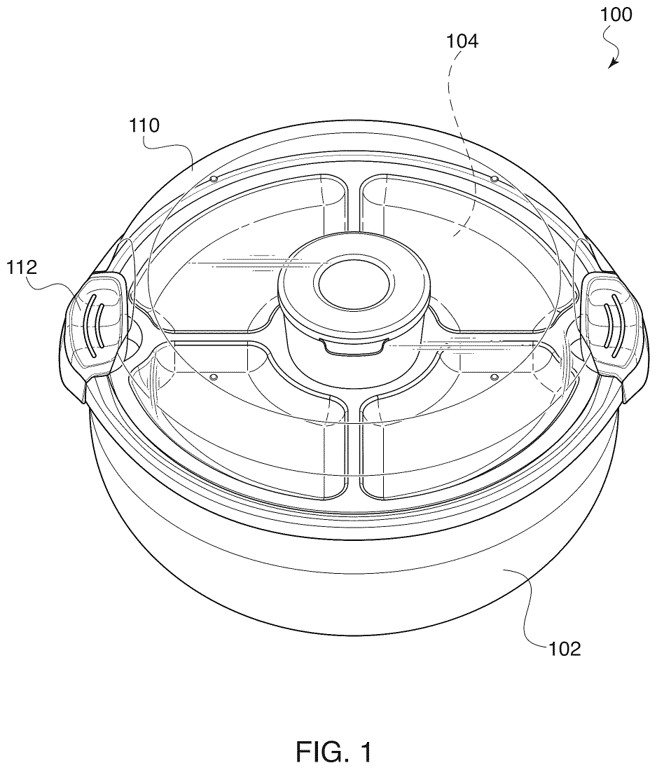

Referring to FIG. 1, there is shown the food preparation and serving system 100 according to one implementation of the present invention. The system 100 includes a bottom or base bowl 102, a combined serving board/cutting board 104 positioned in the opening of the bottom/base bowl 102 and a removable cover 110.

In the following embodiments, it is to be appreciated that the base or bowl 102 and the combined serving board/cutting board 104 can be made of any appropriate materials for food preparation and/or serving or any combinations thereof. This includes, but is not limited to wood, plastics, silicone, and/or any combinations of the same.

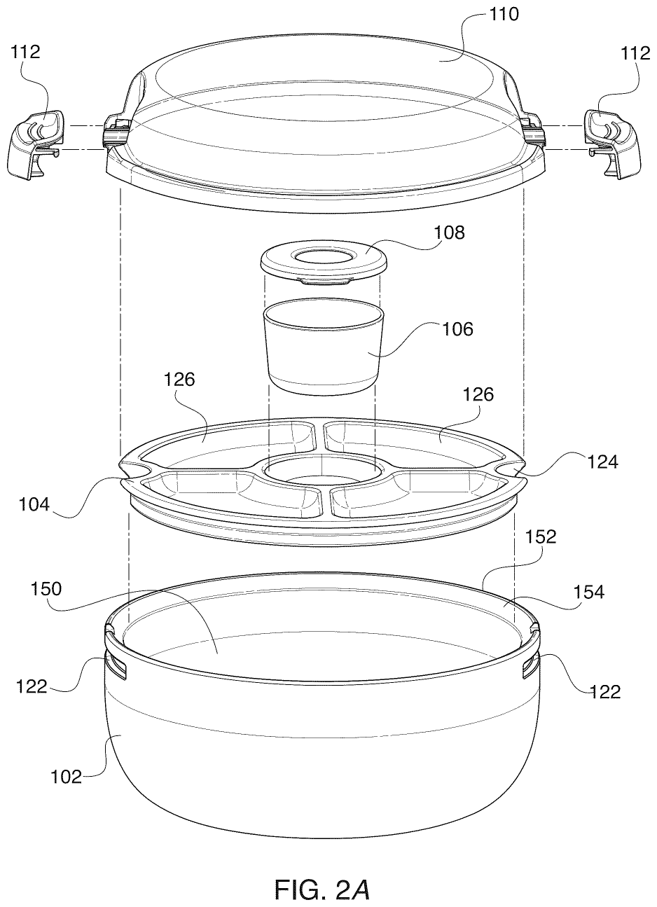

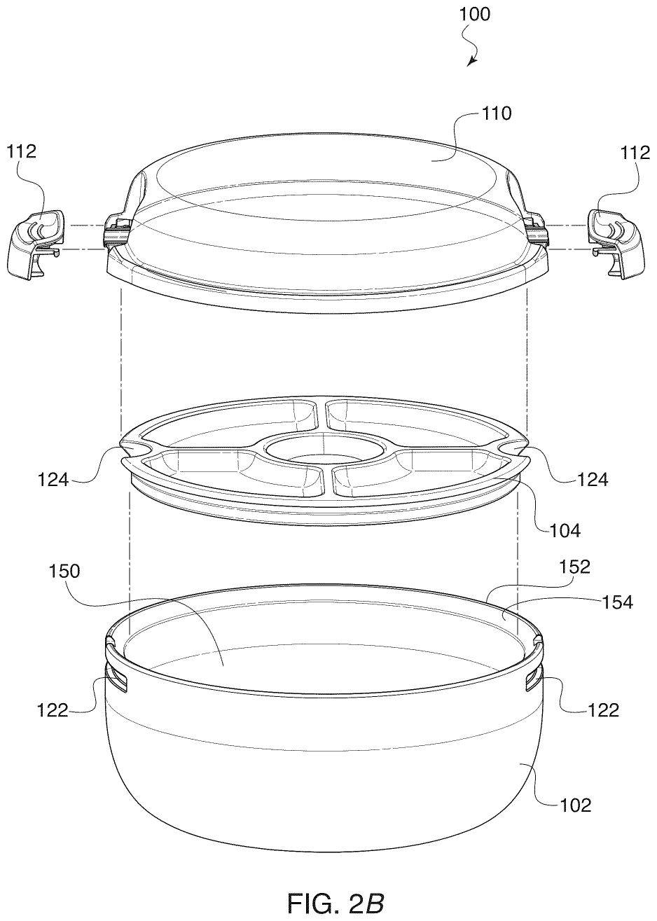

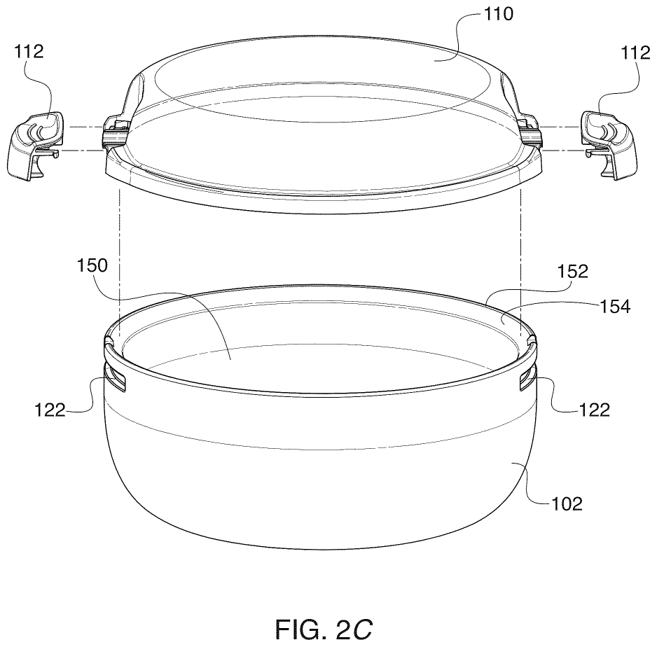

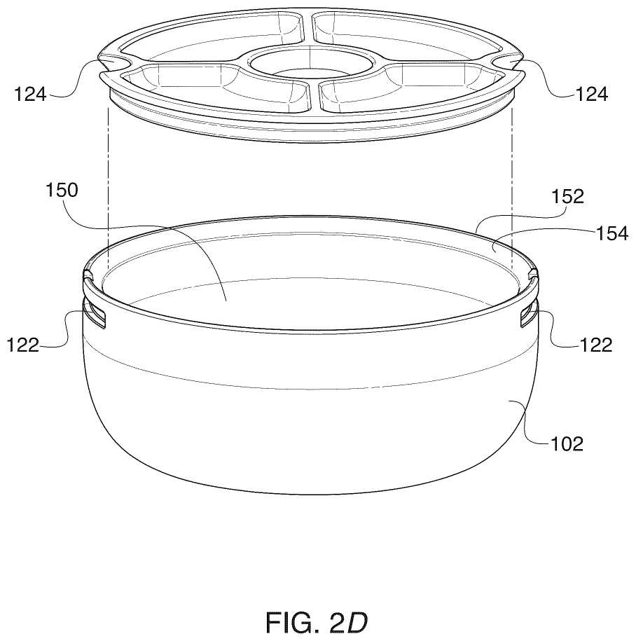

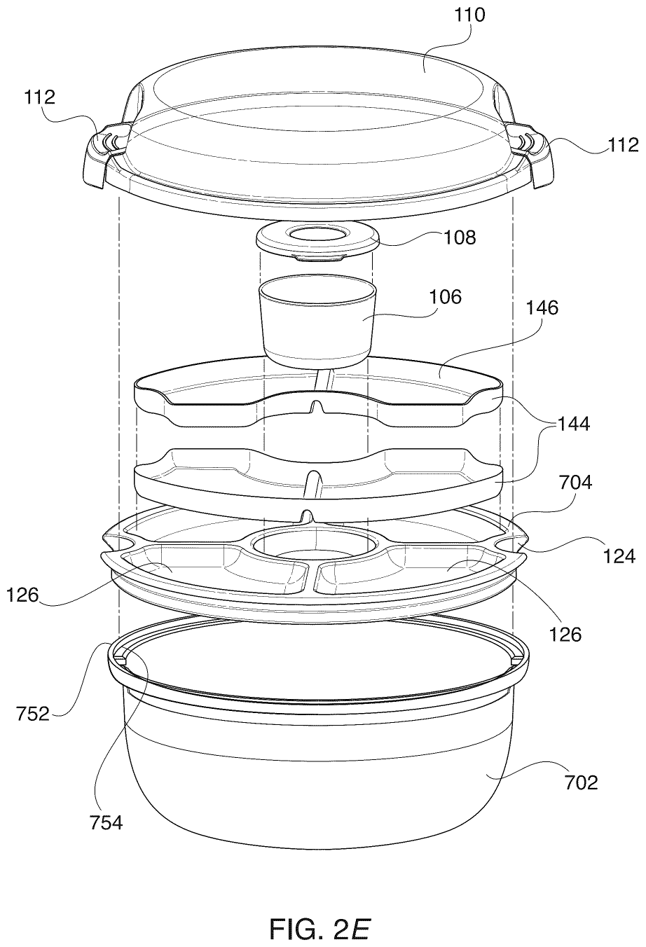

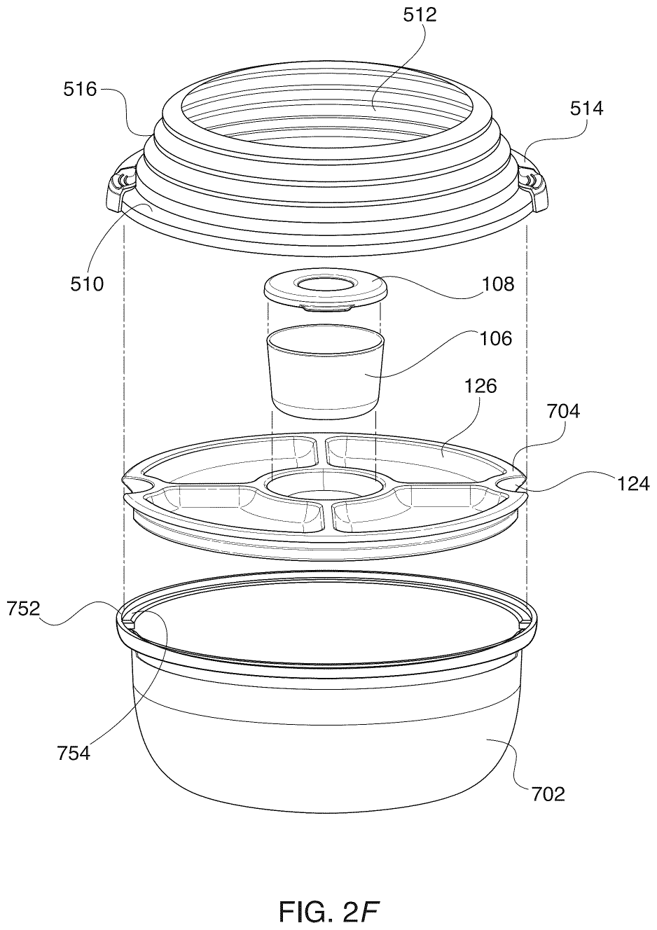

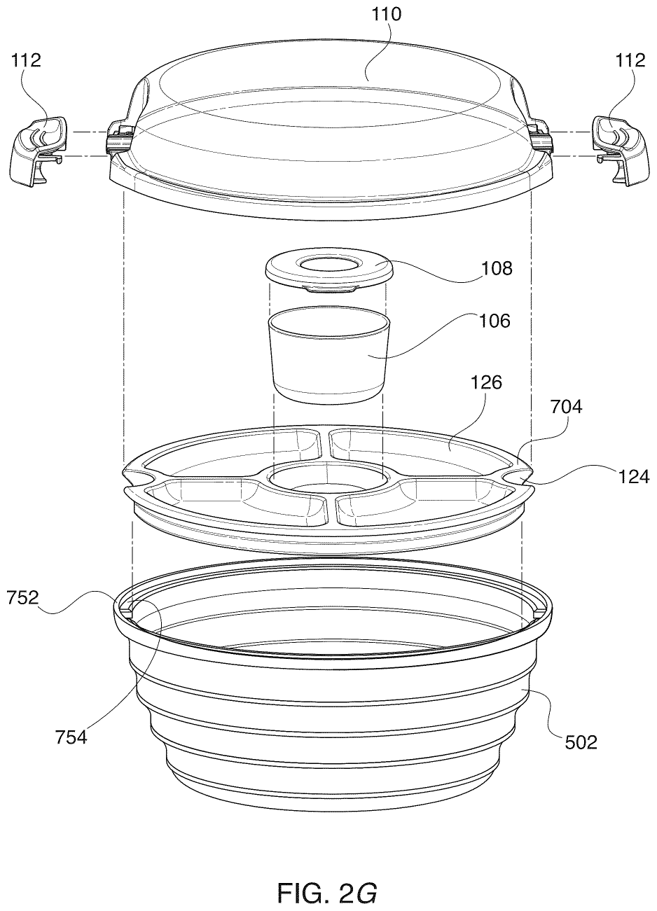

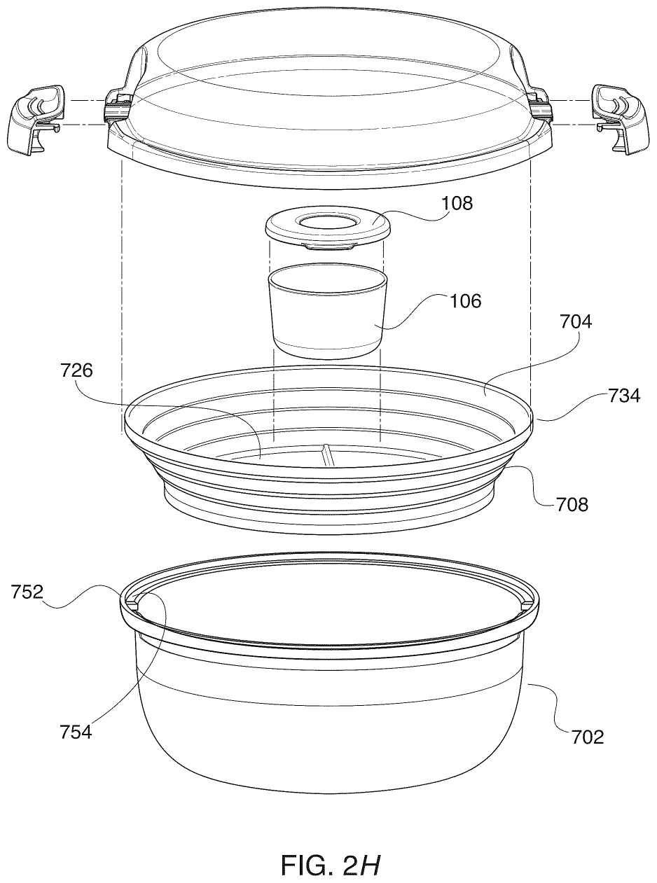

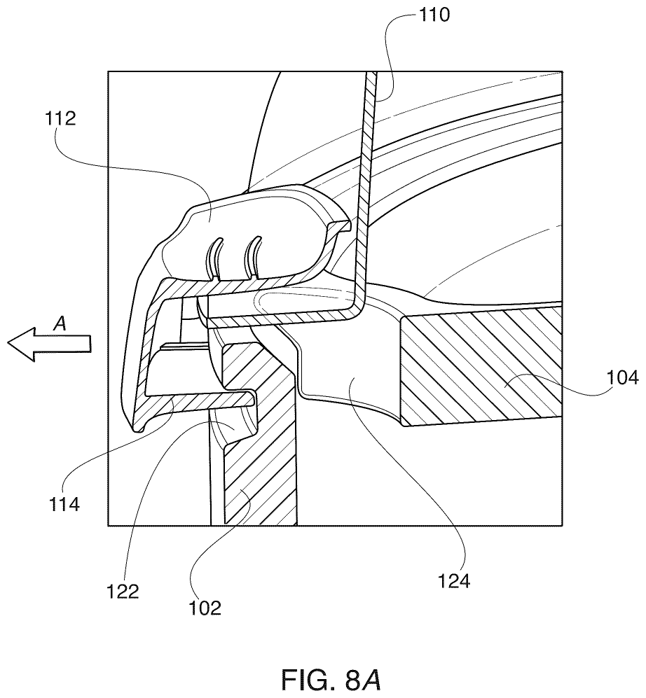

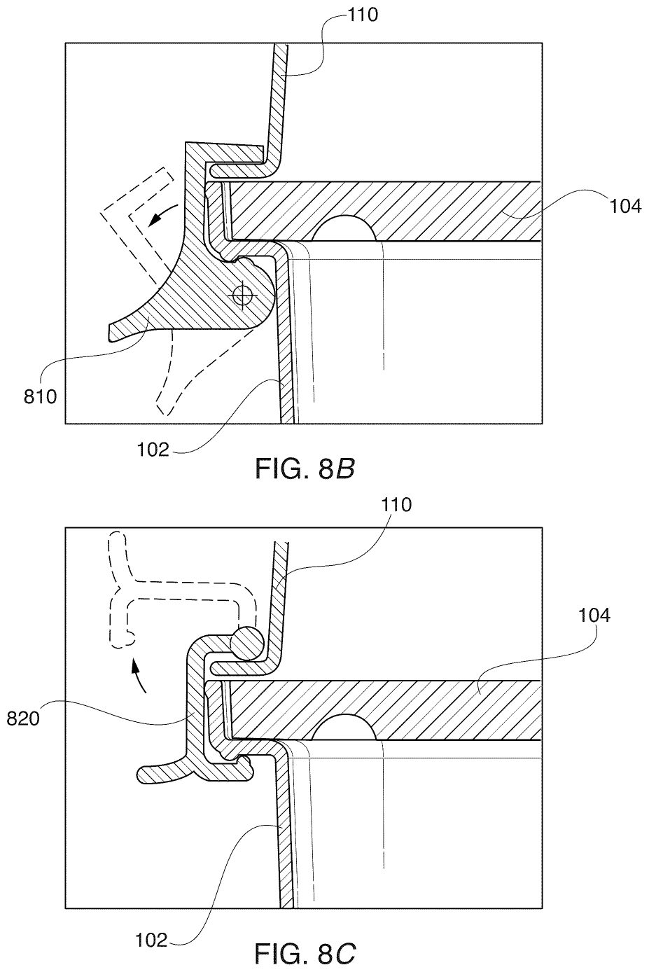

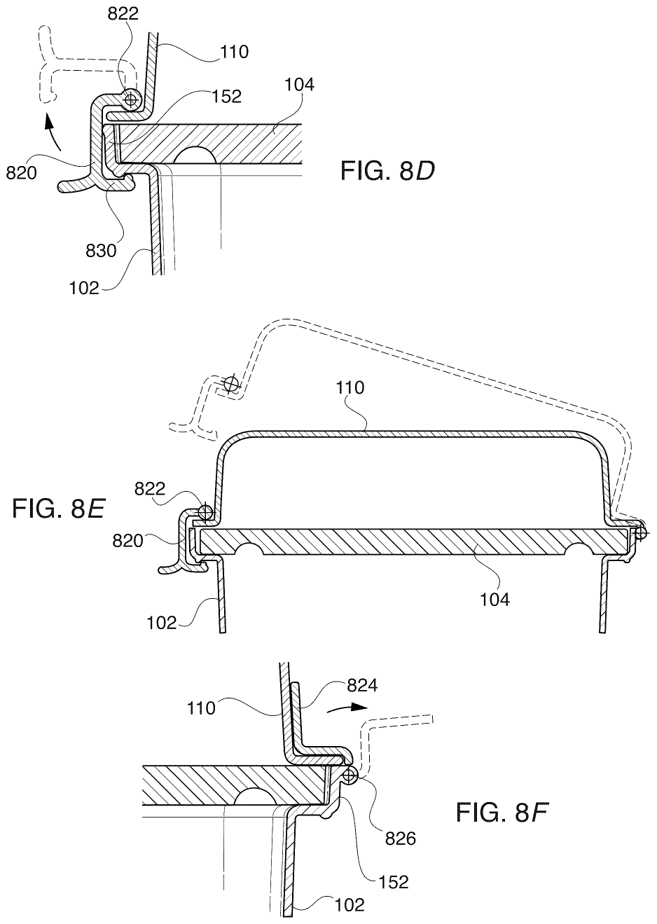

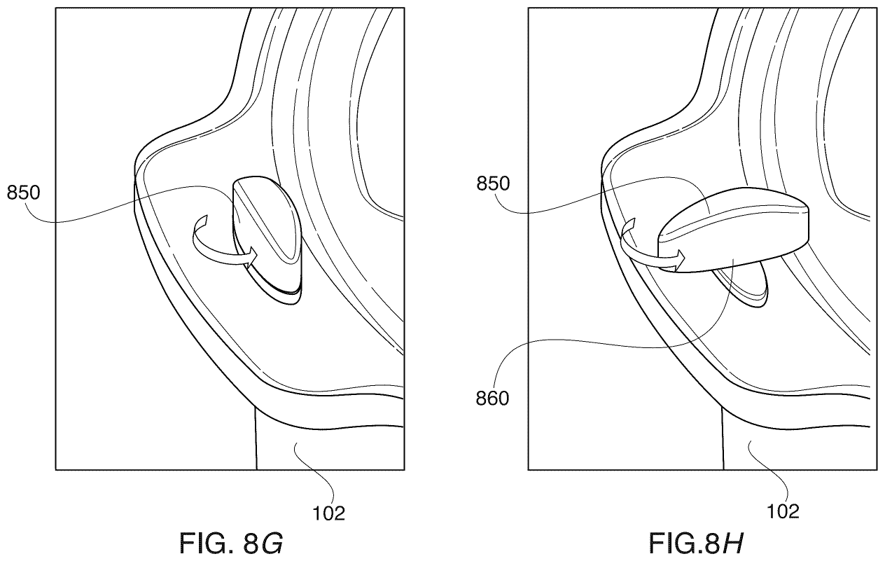

FIGS. 2A-2D shows some variations in the food preparation and serving system in accordance with alternative embodiments. FIG. 2A shows the bowl 102 with the combined serving board/cutting board 104 having a plurality of compartments or depressions that operate as compartments 126 of various sizes and shapes for the serving of food products. In this implementation, the bowl 102 has an opening 150, an upper perimeter edge 152, and an angled surface 154 immediately adjacent the upper edge. As will be described in more detail below, the board 104 nests inside the upper most portion of the bowl as defined by the angled surface 154 and corresponding angled surface on the edge of the board 104 (described in more detail below) such that the board 104 sits flush with the opening and the upper perimeter edge 152 of the bowl. At least one opening or recess 124 is provided on the edge of the board 104 that assists in the removal of the board 104 from a nested position in the bowl opening 150. In this embodiment a container 106 with a cover 108 can be positioned in the central compartment. A cover 110 is provided with locking handles 112 configured to engage the openings 122 in the upper sides or outer rim 152 of the bowl 102. The details of the locking handles 112 and alternative arrangements of the same will be discussed below in reference to FIGS. 8A-8G. In this configuration, the container 106 with cover 108 fits in the central compartment 126 and the cover 110 locks in over the same, thus securing the entire food preparation/serving system for safe movement/travel.

In another alternative configuration, the base or bowl 102 can be configured to receive one or more boards 104 such that they do not necessarily sit flush with the upper edge or rim of the bowl.

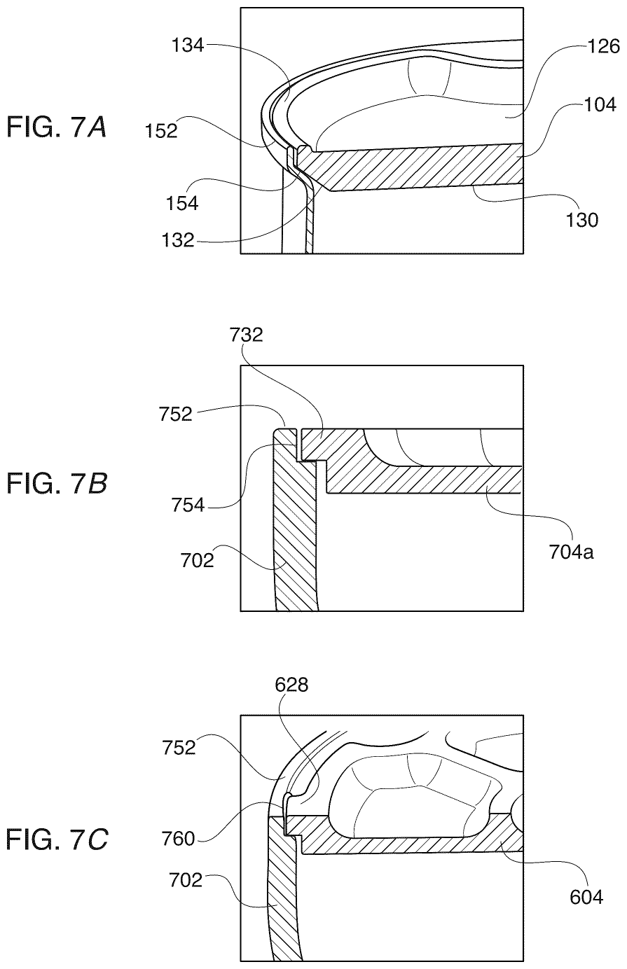

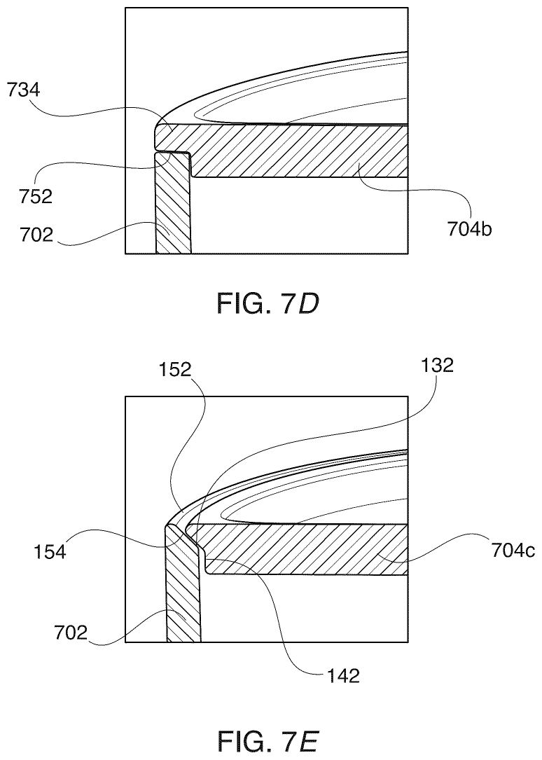

FIG. 2B shows an alternative embodiment of the system 100 without the container 106 and corresponding cover. FIG. 2C shows the system 100 without the combined serving/cutting board 104. FIG . 2D shows the system 100 with just the bowl 102 and the combined serving/cutting board 104. The manner in which the combined serving/cutting board 104 rests or nests into the top of the bowl 102 will be described below with reference to FIGS. 7A-7E. FIG. 2E shows an alternative implementation of the system 100 where the other serving trays 144 are added that can fit over the combined serving/cutting board 704. FIG. 2F shows an alternative implementation of the system 100 where the cover 510 is a collapsible cover having an outer edge 514, a collapsible body 516 and a transparent top 512. FIG. 2G shows another alternative implementation of the system 100 where the bowl 502 is collapsible. FIG. 2H shows yet a further alternative implementation of the system 100 where the combined serving/cutting board 704 has a collapsible body 708, with compartments 726 positioned at the bottom thereof.

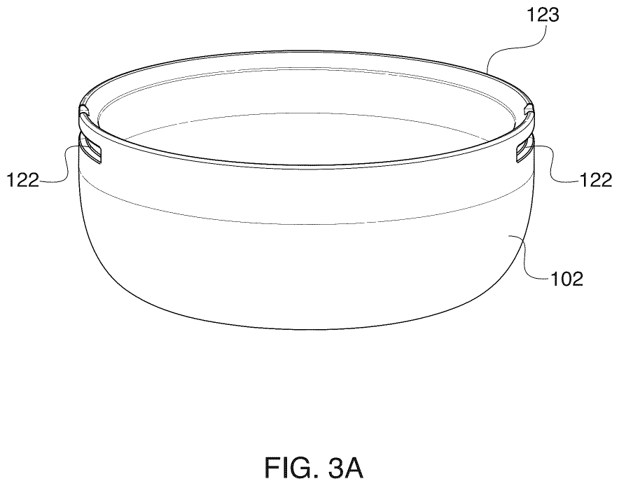

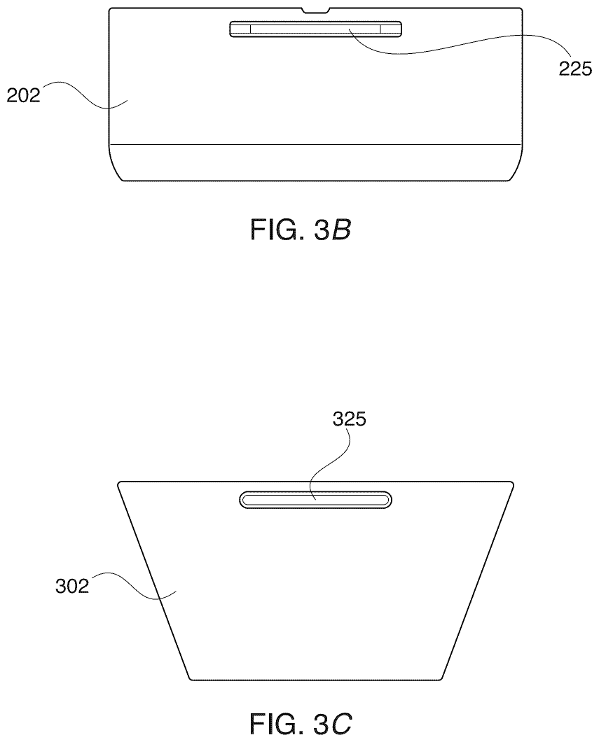

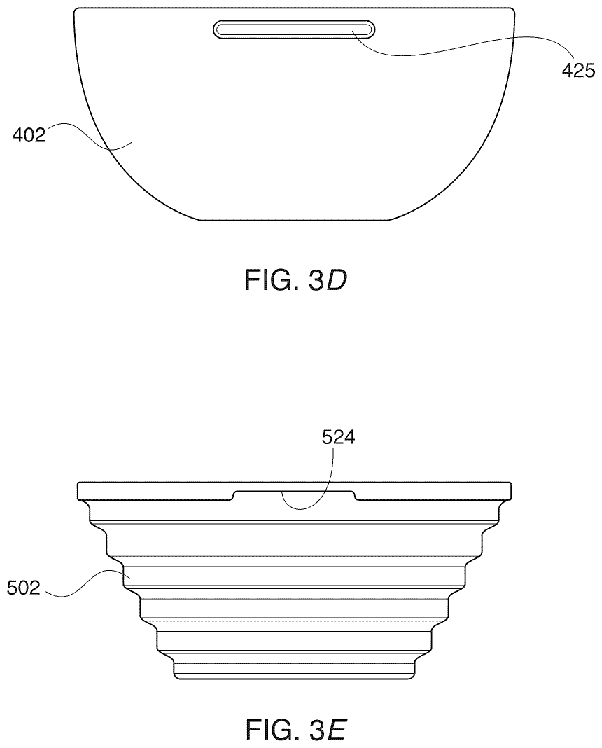

FIGS. 3A-3E show side views of various different geometric configurations of the base bowl 102 according to other contemplated implementations of the invention. FIG. 3A shows a cylindrical shape with large rounded bottom bowl 102 according to primary example of this disclosure. This embodiment shows the openings or recesses 124 in the sides for receiving and locking the handles of the cover. FIG. 3B shows cylindrically shaped bowl/base 202 with the openings or recesses 224 for receiving the locking handles of the cover. FIG. 3C shows upside down cone shape or frusto-conical shaped base/bowl 302 having the openings or recesses 324 for receiving the locking handles of the cover. FIG. 3D shows a round bowl shape for the base/bowl 402, also having the openings or recesses 424 for receiving the locking handles of the cover. FIG. 3E shows a collapsible base/bowl 502 having a notch 524 configured to receive the locking handles of the cover.

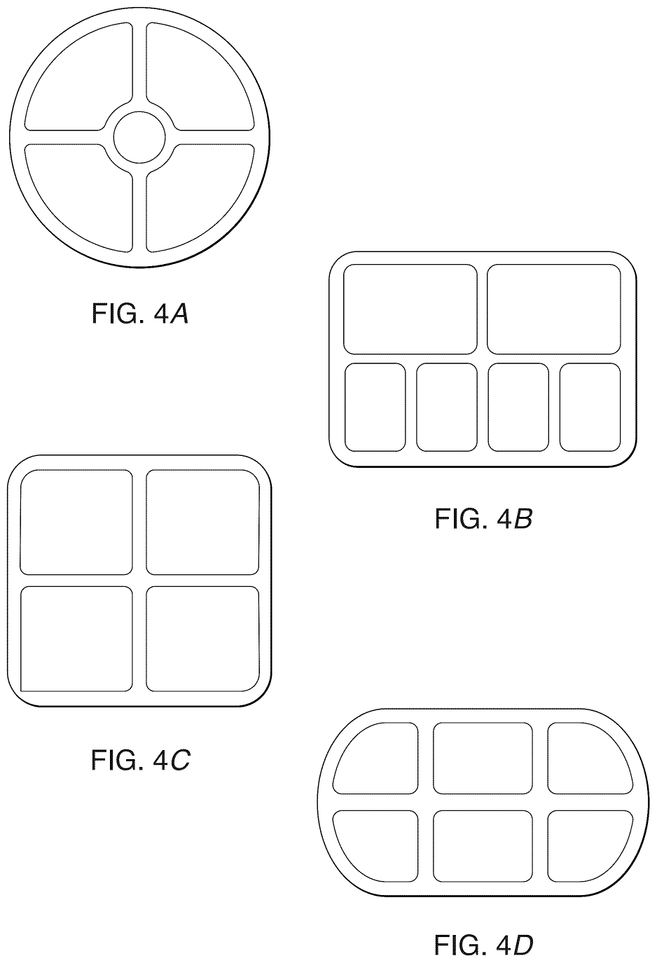

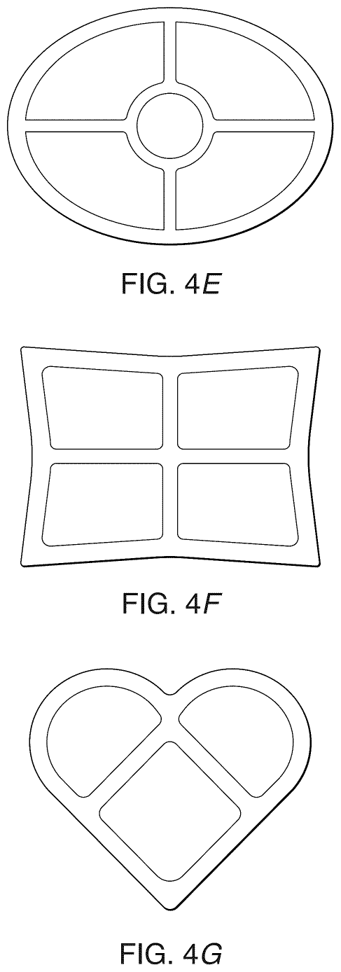

FIGS. 4A-4G show a wide array of different geometric shapes for the cover 110 and underlying combined serving/cutting boards 104 and bowls 102. As will be appreciated by the foregoing, many different geometric shapes can be implemented without departing from the scope and spirit of the present invention.

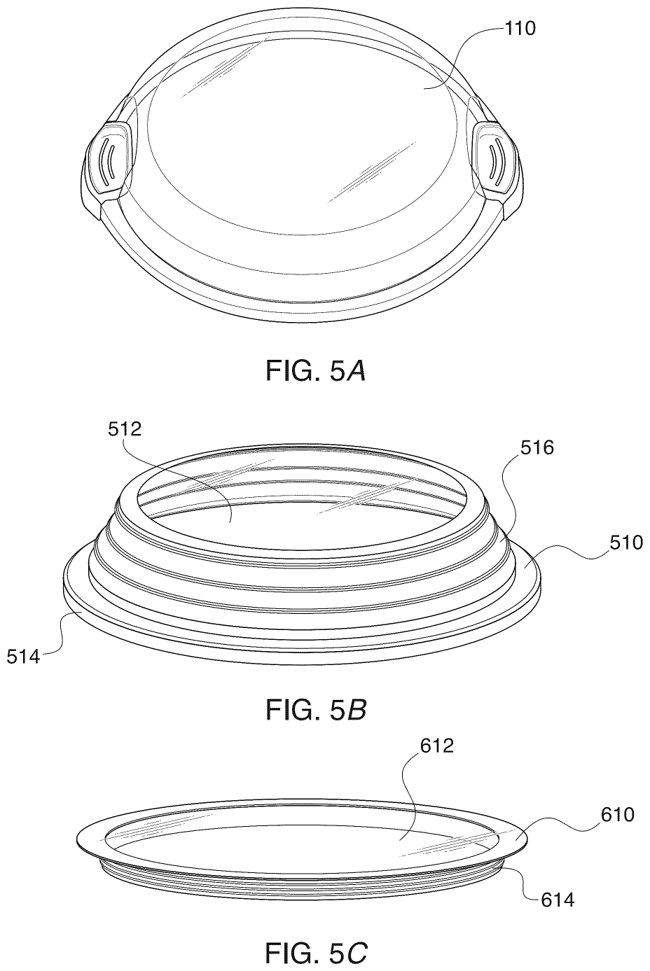

FIGS. 5A-5C show different forms that the cover can take. FIG. 5A shows a cover 110 primarily made of a transparent material. FIG. 5B shows cover 510 that is collapsible and includes a transparent top 512 that is connected to an outer or wide base portion 514 by an accordion like collapsible structure 516. Those of skill in the art will appreciate that the collapsible structure 516 can be made of, for example, silicone. FIG. 5C shows another cover 610 that has a transparent top surface 612, and a lower press fit ring 614 configured to fit into, for example, the opening of the bowl without the combined serving/cutting board.

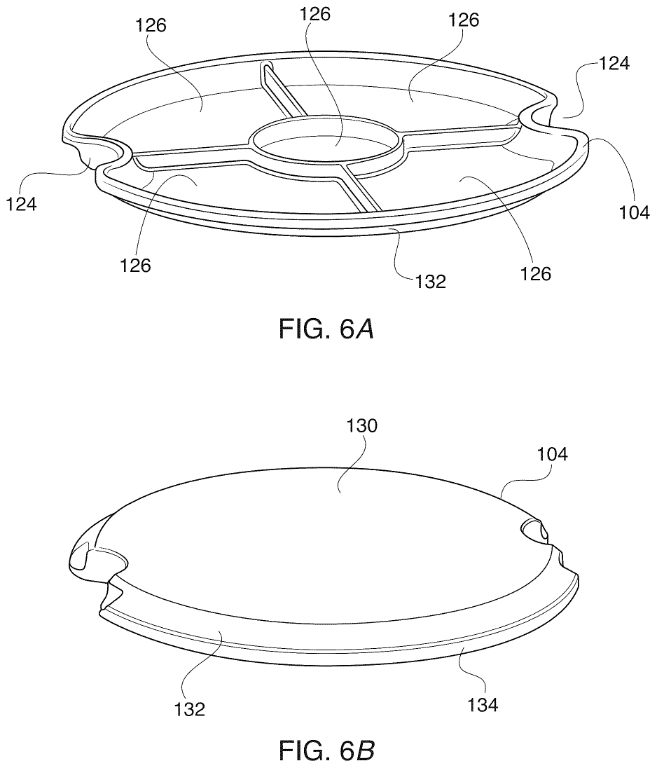

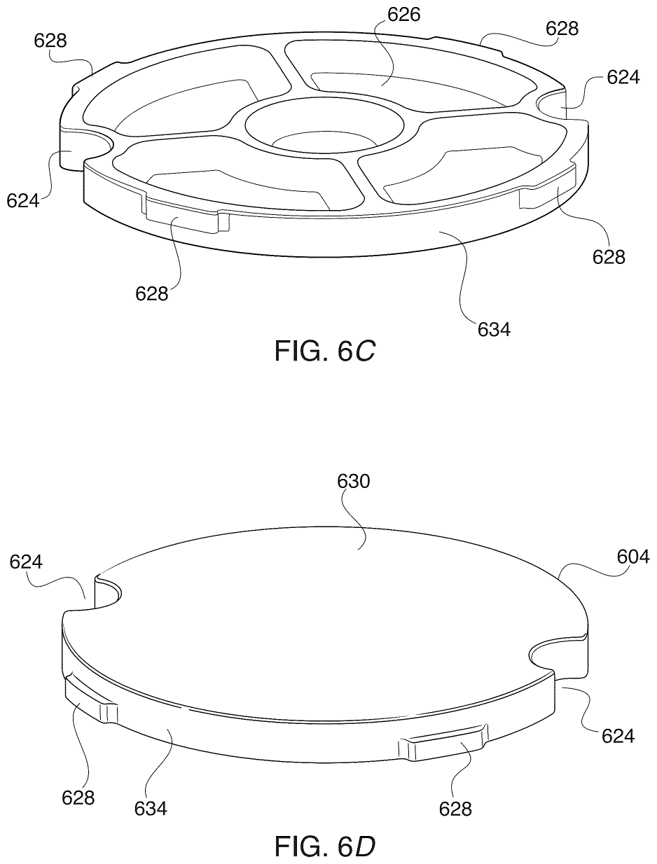

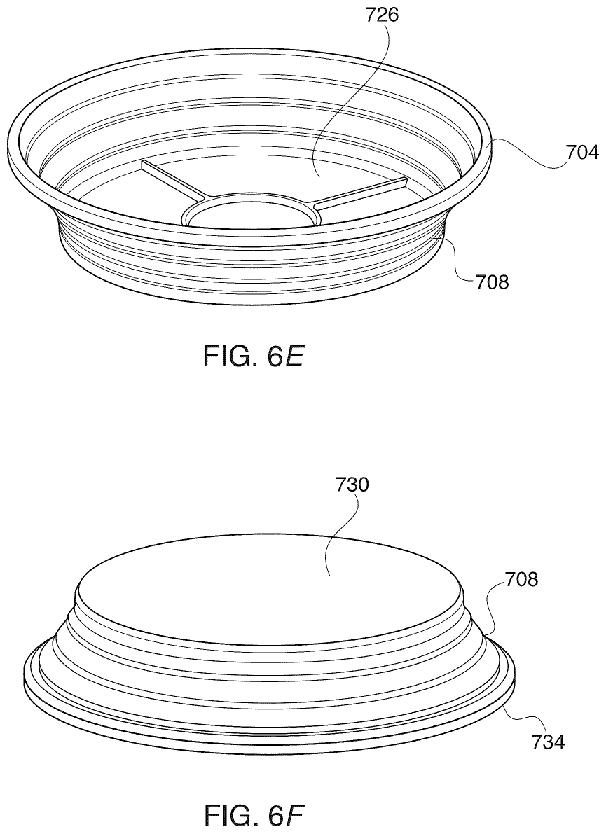

FIGS. 6A and 6B show the top and bottom view of an exemplary combined serving board and cutting board 104 according to one embodiment. On the upper side (FIG. 6A), the board 104 includes a variety of compartments or depressions 126 configured to receive food items to be served. The board 104 can include one or more openings, recesses or cutouts 124 that enable the user to easily remove the board 104 from a nested position in the top of the bowl. The underside of the board 130 (FIG. 6B) is a flat surface configured as a cutting surface for food preparation. As will be described in further detail below, the board 104 has an angled surface 132 extending from the outer rim 134 toward the cutting surface 130. This angled surface 132 us configured such that the board rests or better stated nests within the bowl along the top thereof, without falling into the bowl.

FIGS. 6C and 6D show an alternative implementation or embodiment of the combined serving/cutting board 640. One or more cutouts 624 is provided to assist the user in removing the board 640 from its nested position within the bowl. Further, in this implementation, the outer rim 624 of the board is straight and includes one or more protrusions 628 positioned around the same. These protrusions are configured to be received into corresponding notches in or within the upper edge of the bowl (See FIG. 7C) such that the board 640 sits flush with the top end of the bowl, and the compartments 626 are facing upward.

FIGS. 6E and 6F show another alternative cover 704 according to yet another embodiment. This cover 704 is collapsible having the accordion like edge 70 connecting the rim 734 to the base or on the underside cutting board 730 or on the upper side to reveal compartments 726.

FIGS. 7A-7E show various implementations of how the board nests/rests within the upper opening of the bowl without falling into the same. Referring to FIG. 7A, the board 104 has an angled surface 132 that is the same angle as the angled surface 154 immediately adjacent the upper edge 152 of the bowl. As shown, the board 104 simply drops into the opening of the bowl and fits perfectly within the bowl opening and through angled surfaces 132 and 154, the board 104 sits flush with the top edge 152 of the bowl.

FIG. 7B shows an alternative embodiment where the board 704 includes a stepped portion 732 around the entire perimeter of the board, and the bowl 702 includes a corresponding notch 754 that receives the board 704 such that it is flush with the top edge 752.

FIG. 7C shows another alternative embodiment corresponding to the board shown and described in FIGS. 6C-6D. In this implementation, the bowl 702 includes one or more notches 760 in the top edge such that the protrusions 628 on the edge of the board 604 align with and drop into the notches 760 as shown.

FIG. 7D shows yet another embodiment where the board 704B includes an outer edge or rim 734 that is notched such that it rests on the top edge 752 of the bowl 702.

FIG. 7E shows a further embodiment where the angled edge 132 of the board is smaller than that shown in FIG. 7A, and a portion of the board 142 on the cutting board side is further recessed into the bowl between the side walls of the same.

FIGS. 8A-8H show various embodiments of mechanisms for locking the cover 110 to the bowl 102 with the board 104 positioned in the top of the bowl.

FIG. 8A shows one implementation of a slide in lock where the handle 112 has a lower portion 114 that is configured to engage the opening or recess 122 in the exterior side of the bowl wall when pushed inward into the same. To release, the handle 112 slides outward in the direction of arrow A to release the lower portion 114 from the opening or recess 122.

FIG. 8B shows a latch style clip 810 that is pivotally attached to the bowl 102 and pivots upward to engage the lower edge of the cover 110 and thereby secure the cover to the bowl.

FIG. 8C shows a clip on style mechanism where the clip 820 could be attached to the bowl 102 and cover 110 as shown, but not pivotally attached to either in any permanent or semi-permanent manner.

FIGS. 8D and 8E show a pivotable clip style mechanism where the clip 820 is pivotally attached to the cover 110 at a point 822 on the same. In this manner, a lower leg or portion 830 “clicks” around and under the bowl rim 152 and snaps using detents, depressions and protrusions, or any other known manner to lock the clip 820 to the bowl rim.

FIG. 8F shows another hinge style clip 824 that is pivotally connected 826 to the rim 152 of the bowl. This hinge style clip does not have to lock and can simply be used as a carry point where a user's hand would hold the clip in the position shown over the cover 110 and board 104. A simple pivoting movement in the direction of the arrow would release the cover and board.

FIGS. 8G and 8H show a knob lock style mechanism for securing the lid to the bowl. In one configuration, the knob 850 is permanently affixed to the bowl, and the cover 110 has an opening 860 in the same to receive the knob 850. When the cover is positioned over the knob as shown, a 90 degree rotation of the knob operates to lock the lid to the bowl as shown in FIG. 8H. It will be appreciated that although described with the knob disposed on the bowl, other implementation where the knob and corresponding locking mechanism is attached to the cover, and the bowl has a receiving hole that receives a locking pawl or the like that when rotated with the knob, operates to lock the lid to the bowl.

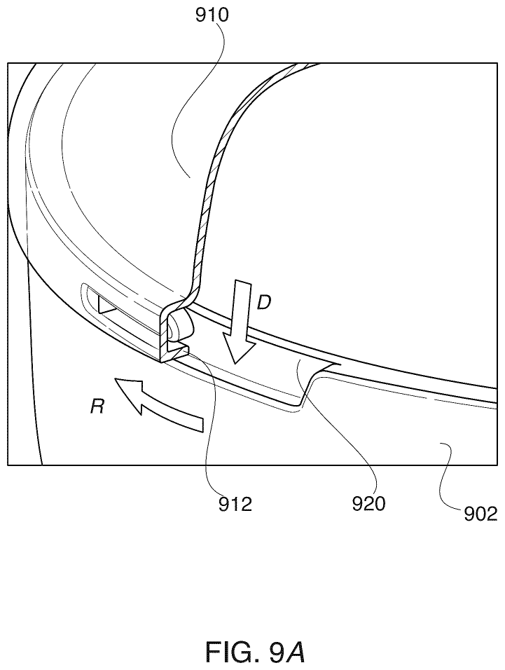

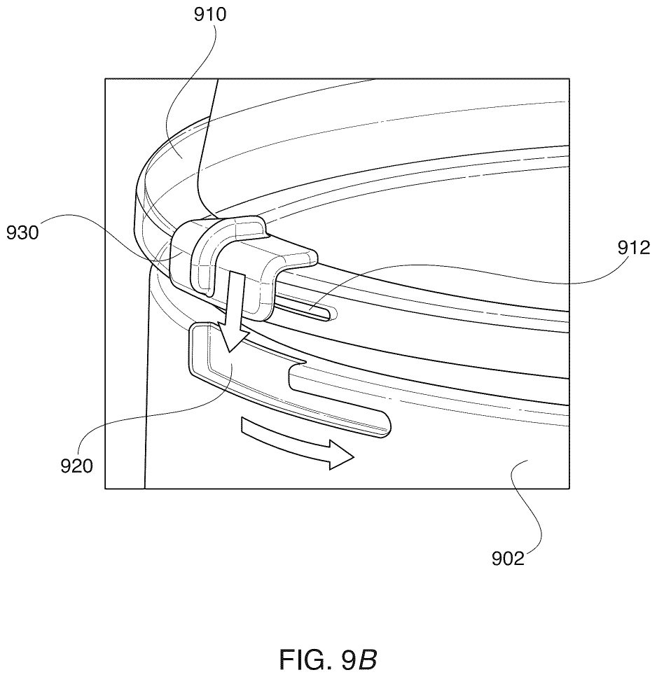

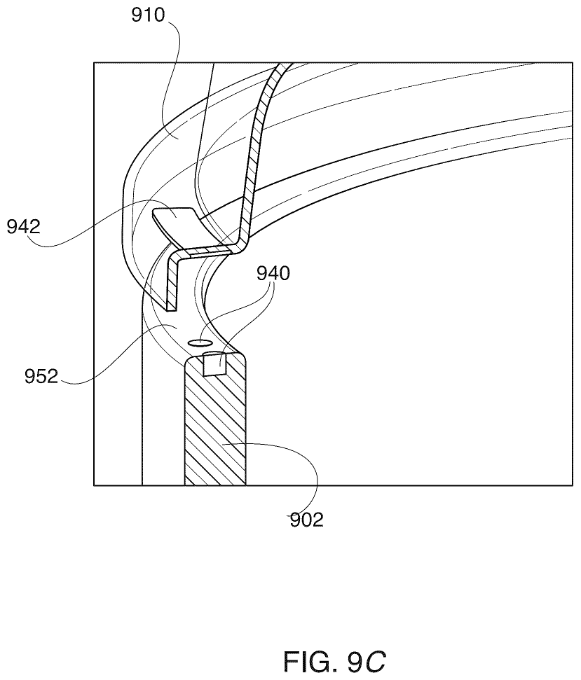

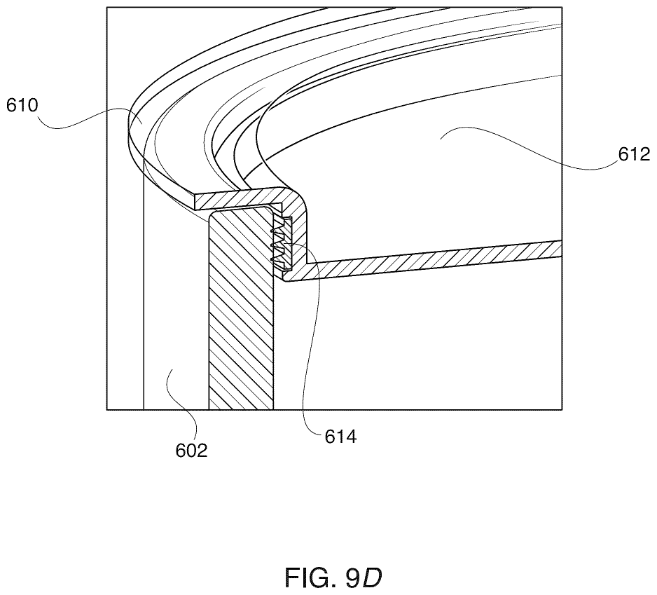

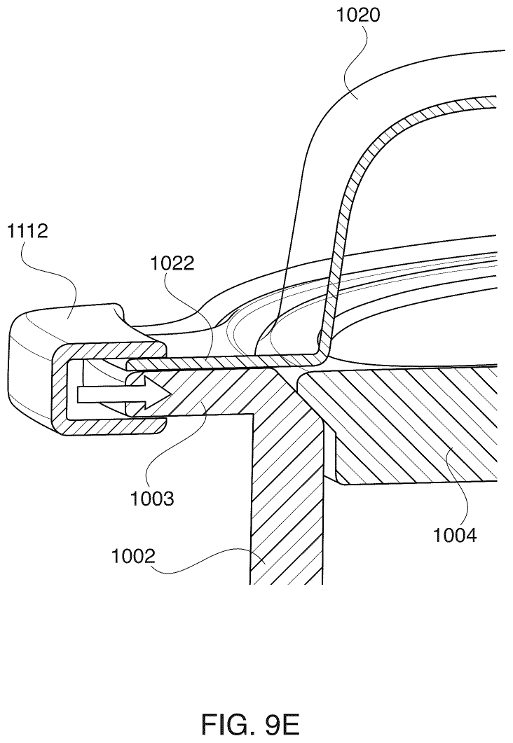

FIGS. 9A-9E shown several other contemplated embodiments for locking the cover to the bowl, in accordance with the present invention.

FIG. 9A shows an embodiment where the bowl 902 has a slot 920 and the cover 910 has a portion 912 configured to fit into an L shaped slot 920 (or in this case a reversed L-shape) and be “dropped” down into the same as indicated by arrow D, and then the cover 910 is slightly rotated in the direction R such that the portion 912 secures into the slot 920. Simply rotating in the opposite direction and lifting action removes the cover from the locked position on the bowl.

FIG. 9B shows another embodiment of a slide and lock mechanism to lock the cover 910 to the bowl 902. A sliding knob 930 is positioned within a slot 912 in the edge of the cover such that the cover is dropped downward into the L-shaped slot 920, once positioned in the slot, the knob 930 is slid horizontally to lock the cover onto the bowl.

FIG. 9C shows another embodiment for securing the cover 910 to the bowl 902 using magnets. One or more magnets 940 can be disposed in the upper edge 952 of the bowl 902, and one or more magnets (of opposite pole) are positioned on the edge of the cover 910. Simple placement of the cover over the bowl will cause the magnets to engage and secure the cover to the bowl.

FIG. 9D shows another embodiment for securing the cover 610 to the bowl 602 using a gasket 614. As shown in the cover of FIG. 5C, a gasket 614 is positioned around the cover, and the cover is sized such that the gasket 614 frictionally engages the inside surface of the bowl opening as shown. Removal of the cover 610 requires a little user force to break the frictional engagement between the gasket 614 and the inside surface of the bowl.

FIG. 9E shows yet another embodiment for securing the cover 1020 to the bowl 1002. As shown, the bowl 1002 has a lip 1004 and the cover has an extended base portion 1022 that are sandwiched together as shown. Once positioned together, a sliding handle 1112 is moved into position securing the sandwiched parts 1004 and 1022, thereby locking the cover 1020 to the bowl 1002.

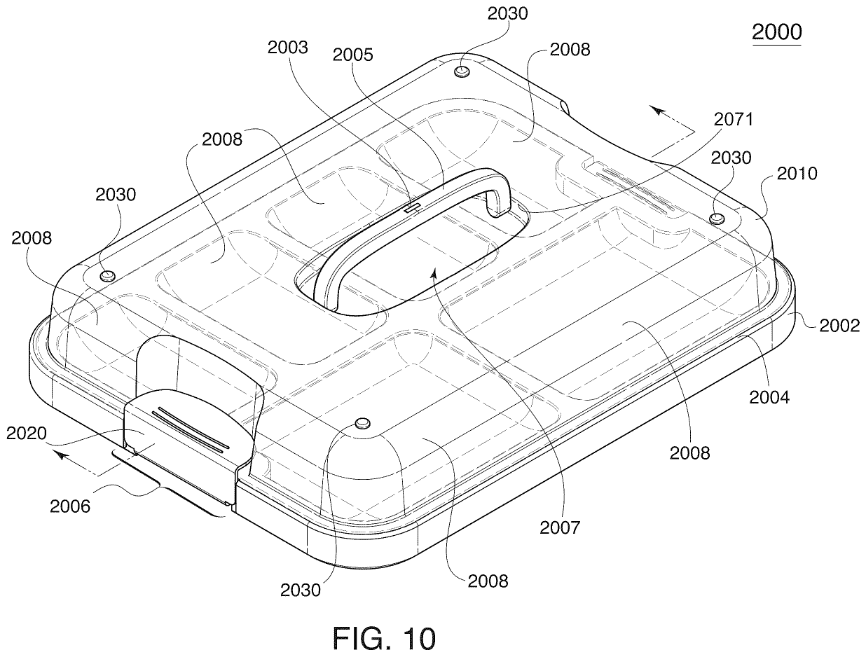

Referring to FIG. 10, a perspective view is shown of a food serving system 2000 according to another implementation of the present invention. The food serving system 2000 includes a base board 2002 and a cover 2010. The base board 2002 has a predetermined geometric shape, shown in this implementation as rectangular, and includes an edge 2004 around the perimeter of the same. The cover 2010 has the same predetermined geometric shape as the base board 2002 and includes at least one dual stage locking handle 2020 configured to lock the cover 2010 in multiple positions relative to the base board 2002.

In this implementation, the base board 2002 includes at least one indentation 2006 in the edge 2004. The indentation 2006 may be positioned to correspond with the location of the dual stage locking handle 2020 on the cover 2010. As shown, two indentations 2006 are positioned opposite each other on the edge 2004 of the base board 2002, and the cover 2010 includes two dual stage locking handles 2020, each positioned and configured to engage one of the indentations 2006.

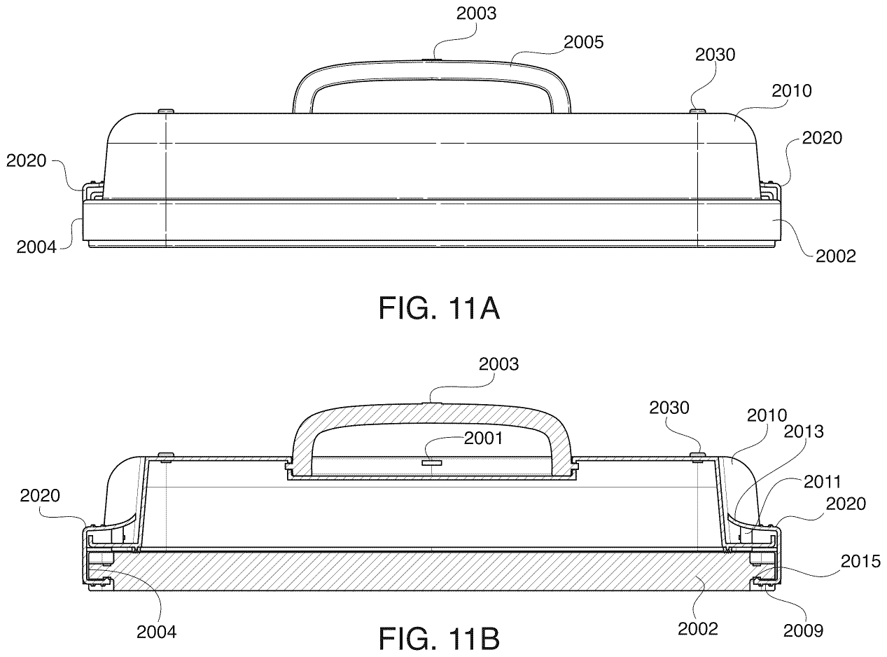

The cover 2010 can be configured in a plurality of different shapes and sizes. The cover 2010 can include a handle 2005 or other gripping mechanism or mechanisms to assist in the placement or removal of the cover 2010. The handle 2005 can be secured within a recess 2007 or other geometric feature. In an embodiment, the handle 2005 includes a protrusion 2003 that can cam into a depression 2001 (FIG. 11A and FIG. 11B). When the handle 2005 is employed for carrying the system 2000 or removing the cover 2010, the handle 2005 is rotated into the position shown in FIG. 10. When the cover 2010 is flipped and resting on support feet 2030, the handle 2005 is stowed within the recess 2007 of the cover 2010 and held in the stowed position by the engagement of the protrusion 2003 and the depression 2001. The handle 2005 can be secured using other mechanism instead of or in addition to the protrusion 2003 and the depression 2001. For example, a similar protrusion and the depression mechanism can be employed on the sides of the handle 2005 rather than the top or any other position on the handle 2005. In another embodiment, an edge 2071 (or edges) of the recess 2007 can include an overhang that the handle 2005 can be cammed past to removably secure the handle 2005 within the recess 2007. Other mechanisms can include flexible tabs or other structures to receive and secure the handle 2005.

The base board 2002 can include a plurality of compartments 2008 on an interior surface thereof for receiving food items. The base board 2002 can include a first surface and second surface opposite the first surface. The first surface can include a cutting board surface or an exterior surface of the system 2000 facing opposite the cover 2010 during transport of the system 2000. The second surface can include compartments 2008 for food storage or for food presentation in some configurations.

FIG. 11A shows a side view of the food serving system 2000 in a storage or carrying configuration. In this first position, the cover 2010 is positioned over the base board 2002 to cover the same. The dual stage locking handles 2020 are engaged with the edge 2004 of the base board 2002 in the area of the indentations 2006 to secure the cover 2010 to the base board 2002. This configuration may be used for storing food items or for transporting the food serving system 2000 from one location to another.

FIG. 11B shows a cross-sectional view of the food serving system 2000 in the storage or carrying configuration. As shown, the base board 2002 is positioned beneath the cover 2010, and the dual stage locking handle 2020 engages the edge 2004 of the base board 2002. When the cover 2010 is positioned over the base board 2002 in this first position, the compartments 2008 and any food items contained therein are held in place by the base board 2002 and are protected by the cover 2010. The base board 2002 can include a cutting board or can itself include compartments for storing food. In an embodiment, the base board 2002 can include compartments that correspond to the compartments 2008 in the cover 2010.

The dual stage locking handle 2020 includes an upper portion 2013 that includes an interface portion 2011 that contacts and holds the cover 2010 to the base board 2002. The dual stage locking handle 2020 includes a lower portion 2009 that captures an undercut 2015 of an end portion of the base board 2002 to secure the base board to the cover 2010.

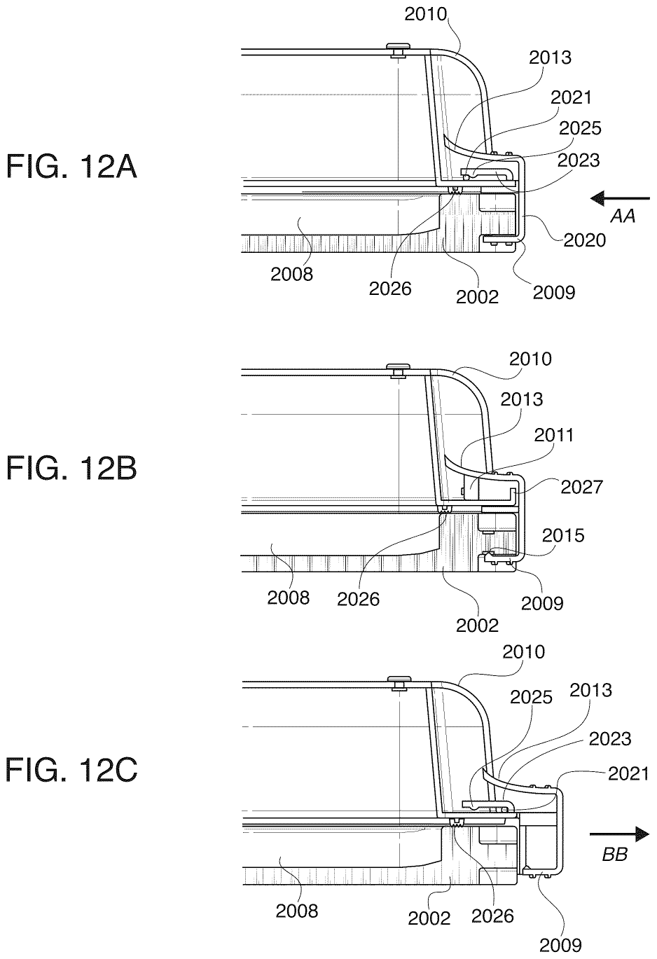

FIGS. 12A, 12B, and 12C show cross-sectional views of various stages of the handle operation of the food serving system 2000 according to implementations of the present invention. FIG. 12A shows the dual stage locking handle 2020 in an engaged position where the handle 2020 is locked in place proximally relative to at the end portion of the base board 2002. In this instance, the dual stage locking handle 2020 includes a track member 2023 having a bulbous portion 2025. The dual stage locking handle 2020 includes a hinge point defined by a hinge rod 2021. When the dual stage locking handle 2020 is moved in the direction of arrow AA, the hinge point (hinge rod 2021) travels down the track of the track member and engages the bulbous portion 2025, which acts as a cam. The track member 2023 flexes to permit the hinge rod 2021 to pass and then the track member 2023 has its position restored to lock the dual stage locking handle 2020 in place to prevent pullout. Said differently, the bulbous portion 2025 locks the hinge rod 2021 in place to prevent the dual stage locking handle 2020 from moved in a direction opposite of arrow AA. The dual stage locking handle 2020 can be released by applying sufficient force to reverse the hold on the hinge rod 2021 by translating the hinge rod 2021 passed the bulbous portion 2025 to release the dual stage locking handle 2020 (See FIG. 12C).

FIG. 12B shows the embodiment depicted in FIG. 11B in greater detail. Here, the dual stage locking handle 2020 is locked in place to prevent pullout by employing the undercut 2015 of the end portion of the base board 2002 to secure the base board to the cover 2010. The dual stage locking handle 2020 can be released from the undercut 2015 and the dual stage locking handle 2020 can slide along a portion of the cover 2010 until a stop portion 2027 of the cover 2010 is reached. The interface portion 2011 can include a flexible material, such as foam, rubber, or the like. The interface portion 2011 is compressed to enable or disable engagement with the undercut 2015 by the lower portion 2009.

FIG. 12C shows the dual stage locking handle 2020 of FIG. 12A in a released position where transverse extension in the direction of arrow BB is provided to release the base board 2002 from the cover 2010. The hinge rod 2021 slides past the bulbous portion 2025 to release the base board 2002 by permitting the hinge rod 2021 of the dual stage locking handle 2020 to rotate to free the base board 2002.

FIGS. 12A-12C show a gasket 2026 that functions as a seal between the cover 2010 and the base board 2002. The gasket 2026 can include a soft material suitable for providing a seal, e.g., TPE or other suitable materials. The gasket 2026 can include a plurality of crush ribs to improve the sealing capabilities.

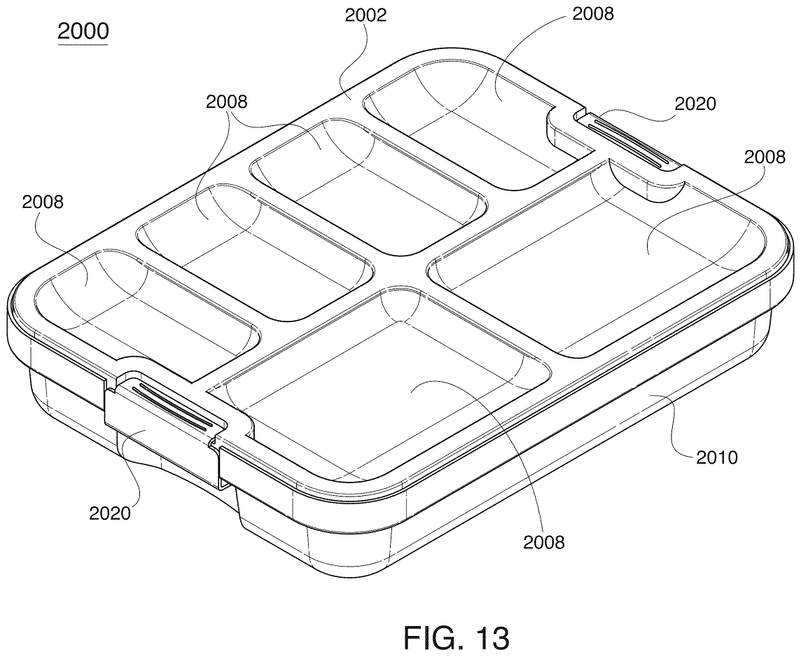

FIG. 13 shows a top perspective view of the food serving system 2000 with the cover 2010 inverted and the base board 2002 resting within the same. In this position, the cover 2010 is turned upside down and serves as a base or tray, while the base board 2002 is nested within or resting upon the inverted cover 2010. The compartments 2008 on the base board 2002 are now exposed and accessible for serving food items. The cover 2010 and the base board 2002 are coupled together by locking the dual stage locking handle 2020 such that the base board 2002 is secured to the cover 2010. In a different configuration, the base board 2002 can be reversed to expose a flat or cutting board portion, which can also be secured by locking the dual stage locking handle 2020.

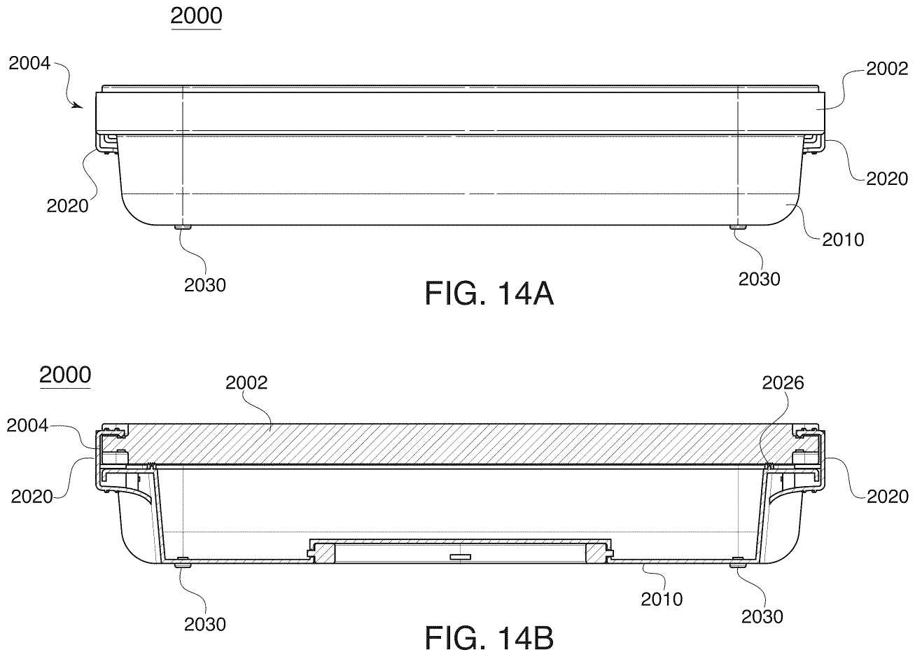

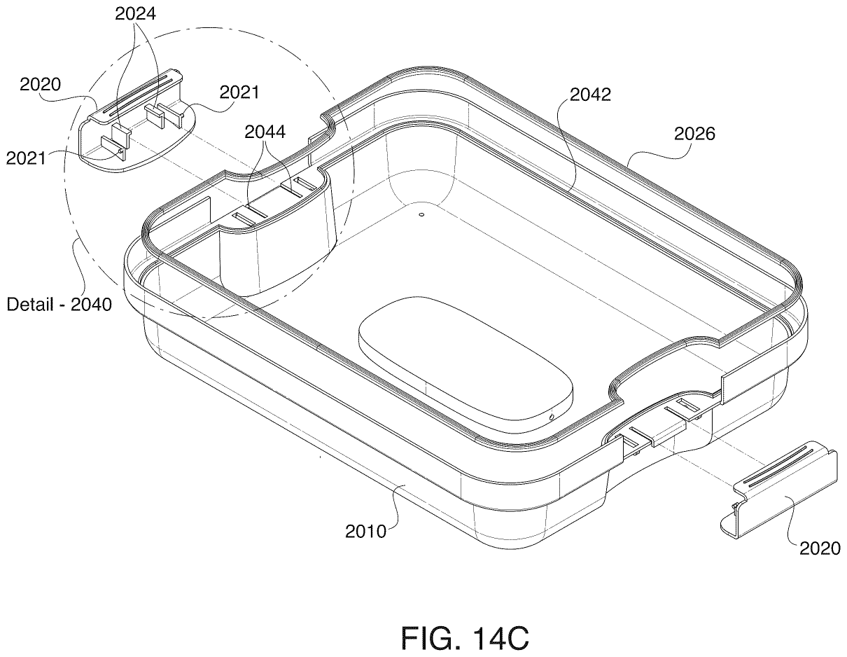

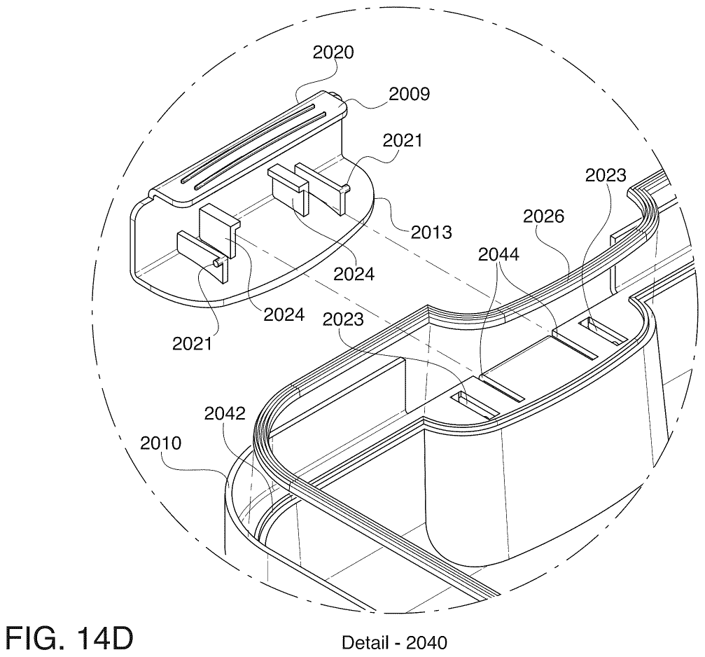

FIG. 14A shows a side view of the food serving system 2000 in the serving configuration. The cover 2010 is inverted with its open side facing upward, and the base board 2002 is secured or nested within the inverted cover 2010. The dual stage locking handles 2020 are engaged with the edge 2004 of the base board 2002 to secure the base board 2002 in the position within the inverted cover 2010. The cover 2010 can include support feet 2030 to provide an interface with a supporting surface. The support feet 2030 can include a material to increase friction to prevent sliding and/or provide a dampening function.

FIG. 14B shows a cross-sectional view of the food serving system 2000 in the serving configuration. As shown, the base board 2002 is flush mounted within the inverted cover 2010. The edge 2004 of the base board 2002 is secured by locking the dual stage locking handle 2020 and is sealed off by the gasket 2026, thereby securing the base board 2002 within the upside down cover 2010.

FIG. 14C shows a partially exploded view of the cover 2010 and the dual stage locking handles 2020 of the food serving system 2000. The dual stage locking handles 2020 are shown separated from the cover 2010 to illustrate the hinge rods 2021 for pivot connection points where the handles 2020 attach to the cover 2010. The dual stage locking handles 2020 can include transverse extensions 2024 that are received in slots 2044. A gasket feature or substrate 2042 receives the gasket 2026 to provide a seal between the cover 2010 and either side of the base board 2002 when engaged in contact with the cover 2010. Detail 2040 is shown in greater detail in FIG. 14D.

FIG. 14D shows an enlarged view of the dual stage locking handles 2020 identified in detail 2040 in FIG. 14C. This enlarged view illustrates the details of the dual stage locking handle 2020, including the lower portion 2009, the transverse extension 2024, and the hinge rods 2021. The hinge rods 2021 connect to cover 2010 and are secured using the track member 2023 (FIG. 12C).

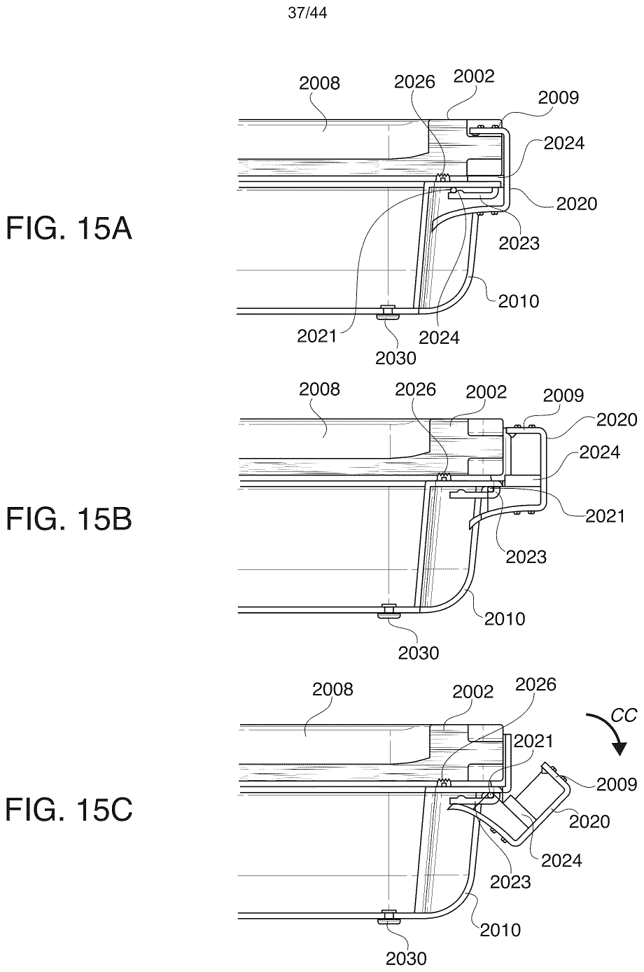

FIGS. 15A-15C show cross-sectional views of various stages of the handle operation of the food serving system 2000 when transitioning to or from the serving configuration. FIG. 15A shows the dual stage locking handle 2020 in an engaged position where the dual stage locking handle 2020 locks the base board 2002 to the cover in a serving configuration as depicted in FIG. 13. The dual stage locking handle 2020 is in a fully engaged position where the edge 2004 of the base board 2002 is captured between the transverse extension 2024 and the hinge rods are secured by the track member 2023 and the bulbous portion 2025. This engagement secures the base board 2002 in the flush mounted nested position within the inverted cover 2010, allowing the food serving system 2000 to be used for serving food items.

FIG. 15B shows an intermediate position where the dual stage locking handle 2020 is being translated away from the base board 2002 to release the transverse extension 2024 and permit pivoting of the dual stage locking handle 2020 about the hinge rod 2021.

FIG. 15C shows the dual stage locking handle 2020 pivoted away from the base board 2002 about the hinge rod 2021 in the direction of arrow CC. In this position, the base board 2002 can be removed from the inverted cover 2010 or repositioned within the same.

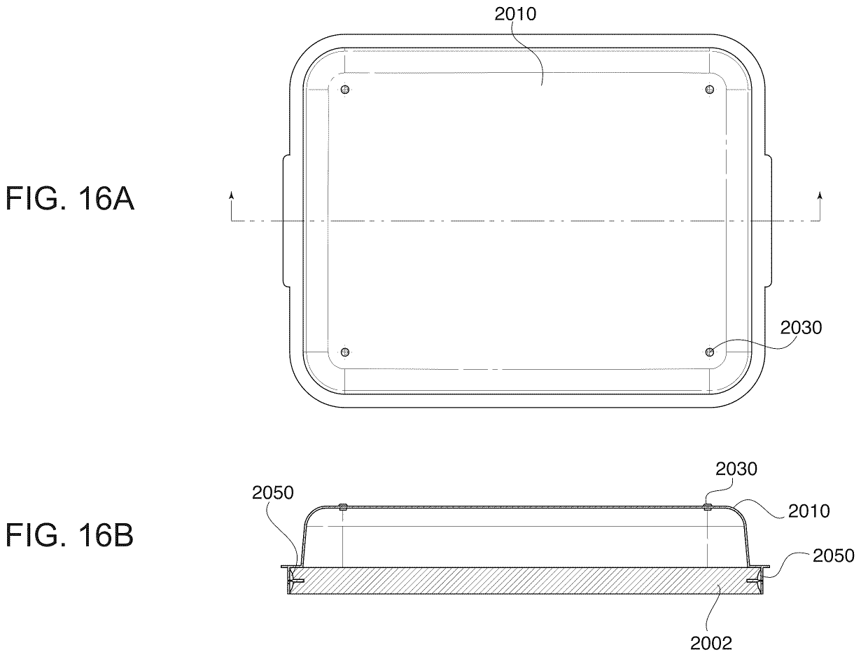

FIGS. 16A and 16B show a top view and cross-sectional view, respectively, of the food serving system 2000 in the storage or carrying position according to another implementation. FIGS. 16A and 16B show the cover 2010 positioned over the base board 2002 with the cover 2010 covering sides of the base board 2002. The base board 2002, in this embodiment, fits within the cover 2010 and a gasket 2050 engages the cover 2010 to maintain connection between the cover 2010 and the base board 2002 (an interference fit) and to provide a seal therebetween.

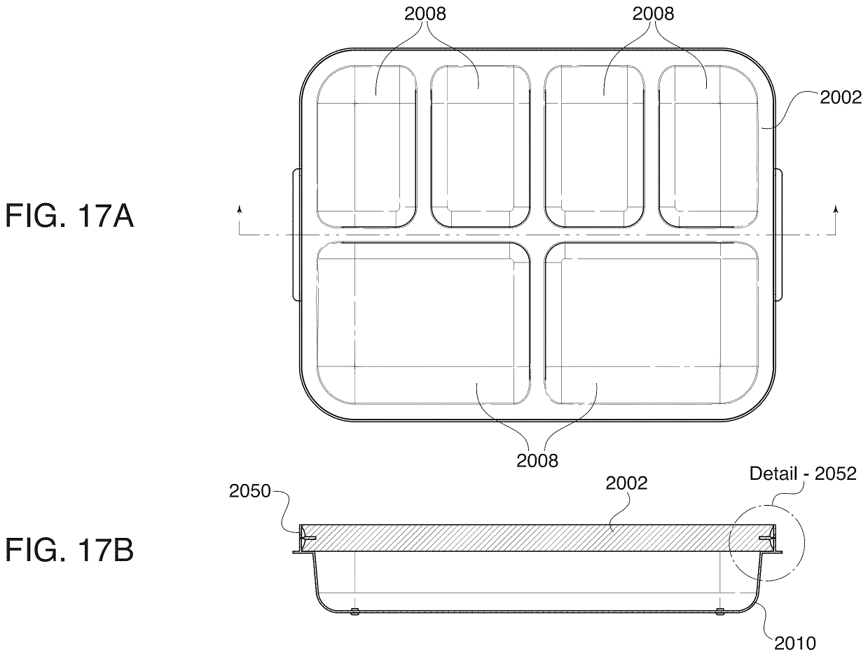

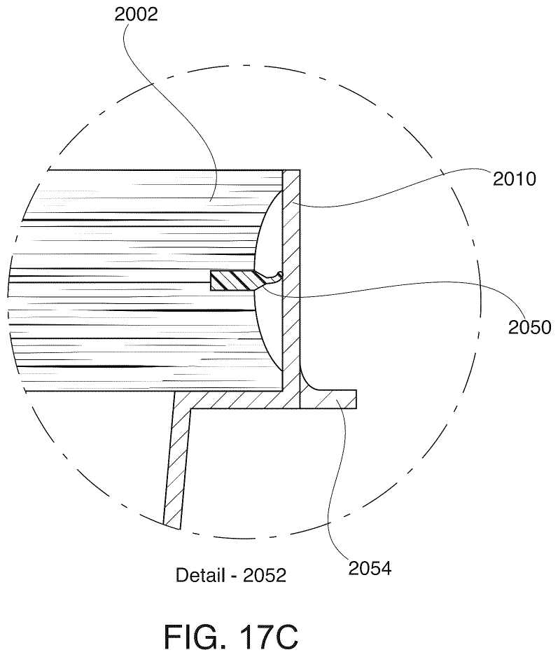

FIGS. 17A and 17B show a top view and cross-sectional view, respectively, of the food serving system 2000 in the serving position according to the implementation of FIGS. 16A and 16B. FIGS. 17A and 17B show the inverted cover 2010 with the base board 2002 nested within the same to secure the base board 2002 in the nested position using the gasket 2050. The compartments 2008 on the base board 2002 are exposed and accessible for serving food items.

FIG. 17B shows a cross-sectional view of this serving configuration, illustrating how the base board 2002 is flush mounted within the inverted cover 2010. The inverted cover 2010 may include support feet 2030 or raised portions on what was originally the top surface to provide stability when the cover 2010 is used as a base in the serving configuration.

In some cases, the base board 2002 may be made of materials suitable for food preparation and serving, such as wood, plastic, silicone, or combinations thereof. The cover 2010 may be made of transparent or translucent materials to allow visibility of the food items contained within when in the storage configuration. In other implementations, the cover 2010 may be made of opaque materials. The base board 2002 can be reversed and used to store food with the cover 2010. In this position, the base board 2002 can have an exterior surface be employed as a cutting board.

FIG. 17C shows a magnified view of detail 2052. The gasket 2050 is recessed within the end portion of the base board 2002. The gasket 2050 seals and secures the base board 2002 within the cover 2010 by providing an interference fit between the cover 2010 and the base board 2002. The interference fit can be broken by bending the cover 2010 away in the direction of arrow DD to release the base board 2002 from the cover 2010. A lever 2054 can be provided to assist in increasing a moment arm to bend the cover 2010 away. The base board 2002 can be reversed.

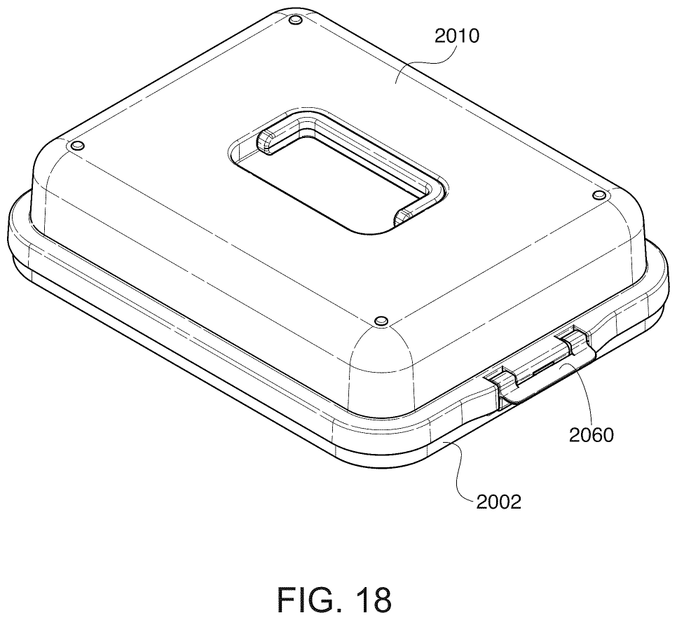

FIG. 18 shows the serving system 2000 having the cover 2010 attached to the base board 2002 by locking handles 2060 in accordance with another embodiment. Locking handles 2060 are spring loaded to a closed position to secure the cover 2010 to the base board 2002. FIG. 18 shows a storage configuration.

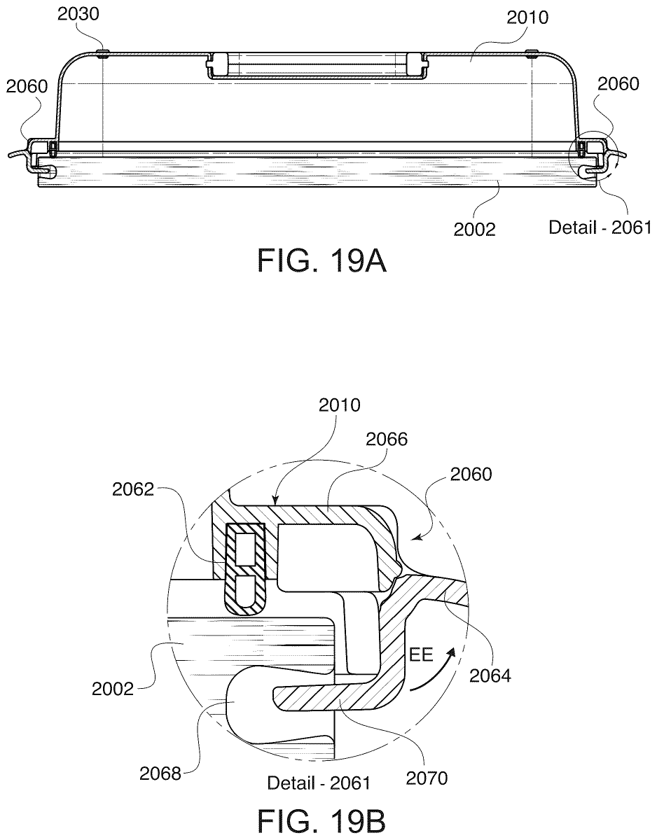

FIG. 19A is a cross-sectional view of the serving system 2000 of FIG. 18. FIG. 19A includes a detail 2061, which is enlarged in FIG. 19B. FIG. 19B shows the cover 2010 having an anchor portion 2066. A handle portion 2064 is coupled to the anchor portion 2066 such that a hinged connection is created, The hinged connection can include an overmolded plastic connection or other spring loaded connection mechanism that permits the handle portion 2064 to flex upward in the direction of arrow EE to disengage a lock portion 2070 from a centrally disposed recess 2068 within an end portion of the base board 2002. This releases the base board 2002 from the cover 2010. A gasket 2062 can be employed to provide a seal and to provide a bias by the cover 2010 against the handles 2060.

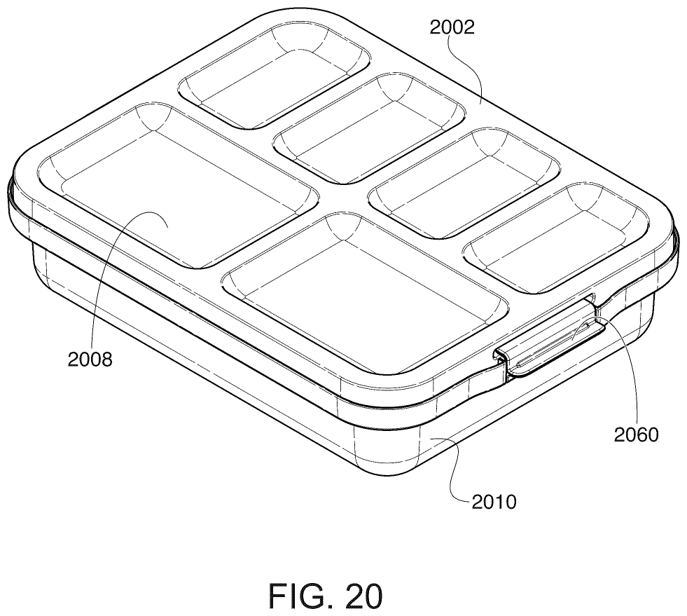

FIG. 20 shows the serving system 2000 having the cover 2010 attached to the base board 2002 by locking handles 2060 in a serving position. Here, the base board 2002 has been reversed from the storage position or configuration shown in FIG. 18.

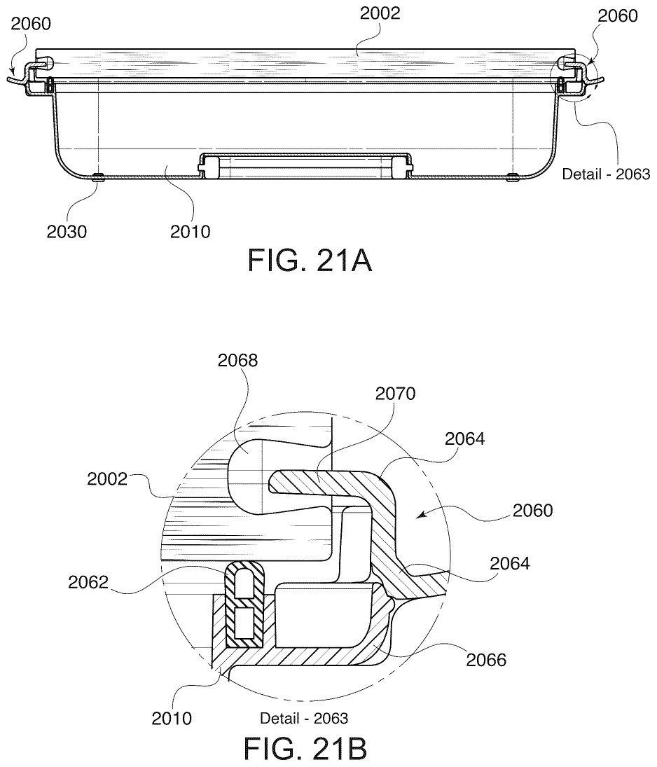

FIG. 21A is a cross-sectional view of the serving system 2000 of FIG. 20. FIG. 21A includes a detail 2063, which is enlarged in FIG. 21B. FIG. 21B shows the cover 2010 having the anchor portion 2066. The handle portion 2064 is coupled to the anchor portion 2066 such that a hinged connection is created, The hinged connection can include an overmolded plastic connection or other spring-loaded connection mechanism that permits the handle portion 2064 to flex downward to disengage the lock portion 2070 from a centrally disposed recess 2068 within the end portion of the base board 2002. This releases the base board 2002 from the cover 2010. The recess 2068 is centrally located so that the base board 2002 can be flipped and reversed to be employed in a serving configuration or a storage configuration.

While there have been shown, described and pointed out fundamental novel features of the present principles, it will be understood that various omissions, substitutions and changes in the form and details of the methods described and devices illustrated, and in their operation, may be made by those skilled in the art without departing from the spirit of the same. For example, it is expressly intended that all combinations of those elements and/or method steps which perform substantially the same function in substantially the same way to achieve the same results are within the scope of the present principles. Moreover, it should be recognized that structures and/or elements and/or method steps shown and/or described in connection with any disclosed form or implementation of the present principles may be incorporated in any other disclosed, described or suggested form or implementation as a general matter of design choice. It is the intention, therefore, to be limited only as indicated by the scope of the claims appended hereto.

It should also be understood that the example embodiments disclosed and taught herein are susceptible to numerous and various modifications and alternative forms. Thus, the use of a singular term, such as, but not limited to, “a” and the like, is not intended as limiting of the number of items. Furthermore, the naming conventions for the various components, functions, parameters, thresholds, and other elements used herein are provided as examples, and can be given a different name or label. The use of the term “or” is not limited to exclusive “or” but can also mean “and/or”.

What is claimed is:

1. A food serving system comprising:
a board having a geometric shape having an edge around the board, the edge having at least one indentation;
a cover having a same geometric shape as the board, and at least one dual stage locking handle configured to lock the board in both a first serving position and a second storage position, when the board is reversed from the first position; and
the at least one dual stage locking handle including a transverse extension to guide the at least one dual stage locking handle to be translated away from the board and pivot away to permit removal of the board from the cover.

2. The food serving system of claim 1, wherein the cover comprises two dual stage locking handles on opposite end portions of the board.

3. The food serving system of claim 1, wherein the at least one dual stage locking handle is pivotally connected to the cover and includes hinged rods that permit rotation of the at least one dual stage locking handle passed the transverse extension.

4. The food serving system of claim 3, wherein the hinged rods fit within a track member and lock the at least one dual stage locking handle in a closed position.

5. The food serving system of claim 4, wherein the track member includes a bulbous portion that cams over the hinged rods to lock the at least one dual stage locking handle in the closed position.

6. The food serving system of claim 1, wherein the at least one dual stage locking handle includes a lower portion that captures a surface on the board which is opposite the cover, when engaged with the cover.

7. The food serving system of claim 1, wherein the board further comprises a plurality of compartments for receiving food items for serving in the first position.

8. The food serving system of claim 7, wherein the board further comprises a cutting board surface on a side opposite the plurality of compartments.

9. A food serving system comprising:
a board having a geometric shape with an edge around a perimeter of the board, the board including an end portion having a gasket recessed therein;
a cover having a same predetermined geometric shape as the board, the cover configured to receive the board in a nested position; and
wherein the gasket provides an interference fit between the cover and the board to seal and secure the board within the cover.

10. The food serving system of claim 9, wherein the board includes a first surface having a plurality of compartments for receiving food items and a second surface opposite the first surface configured as a cutting board surface.

11. The food serving system of claim 10, wherein the board is reversible within the cover such that either the first surface or the second surface faces outward from the cover.

12. The food serving system of claim 9, wherein the cover is invertible such that the cover serves as a base in a serving configuration with the board nested therein.

13. The food serving system of claim 12, wherein the cover includes support feet on a surface thereof to provide stability when the cover is inverted in the serving configuration.

14. The food serving system of claim 9, wherein the interference fit is configured to be released by bending the cover away from the board.

15. The food serving system of claim 9, wherein the gasket comprises a flexible material positioned within a recess in the end portion of the board.

16. A food serving system comprising:
a board having a geometric shape with an edge around a perimeter of the board, the board including an end portion having a centrally disposed recess disposed within a thickness of the board;
a cover having a same geometric shape as the board; and
a locking handle coupled to the cover, the locking handle including an anchor portion secured to the cover and a handle portion coupled to the anchor portion via a hinged connection, the handle portion including a lock portion configured to engage the centrally disposed recess to secure the board to the cover.

17. The food serving system of claim 16, wherein the hinged connection comprises a spring-loaded connection mechanism that biases the handle portion toward a closed position.

18. The food serving system of claim 17, wherein the spring-loaded connection mechanism comprises an overmolded plastic connection.

19. The food serving system of claim 16, further comprising a gasket positioned between the cover and the board to provide a seal therebetween.

20. The food serving system of claim 16, wherein the centrally disposed recess is positioned such that the board is reversible to be employed in either a serving configuration or a storage configuration.
